(19) United States
(12) Patent Application Publication
(10) Pub. No.: US 2025/0370676 A1
(43) Pub. Date: Dec. 4, 2025

(54) STORAGE MEDIUM STORING PROGRAM SUPPORTING GENERAL-PURPOSE PRINT SOFTWARE AND CONTROL METHOD

(71) Applicant: CANON KABUSHIKI KAISHA, Tokyo (JP)

(72) Inventor: SOICHIRO YOSHIGI, Tokyo (JP)

(21) Appl. No.: 19/223,141

(22) Filed: May 30, 2025

(30) Foreign Application Priority Data
Jun. 4, 2024 (JP) 2024-090739

(51) Int. Cl. G06F 3/12

(52) U.S. Cl. CPC G06F 3/1256; G06F 3/1205; G06F 3/1228; G06F 3/1232

(57) ABSTRACT

A mechanism capable of changing a scaling ratio used when a print data is scaled and printed with a printer by a numerical value. A non-transitory computer-readable storage medium storing a program supporting a general-purpose print software that generates print data printable by printers of a plurality of manufacturers and transmits the print data to a printer, the program causing a computer to execute a control method including displaying a setting accepting screen on which a scaling ratio used when the print data is scaled and printed with the printer is accepted by a numerical value, and transmitting numerical value information including the numerical value accepted on the setting accepting screen to the printer.

### BACKGROUND

### Field of the Technology

The present disclosure relates to a storage medium storing a program supporting general-purpose print software and a control method.

### Description of the Related Art

A host computer (an information processing apparatus) capable of processing information with a printer is communicably connected to the printer. As control software to control the printer, for example, a printer driver installed in the host computer from the printer is used. The printer driver enables the host computer to issue a print instruction to the printer. An operating system (hereinafter referred to as an “OS”), which is basic software, is installed in the host computer in advance. The printer driver has a configuration in accordance with the specification defined by the OS, and can be called from the OS to operate. In addition, such a printer driver is different for each vendor that supplies a printer, that is, a printer driver is specific to a model suitable for each printer.

In recent years, Windows (registered trademark) provides a standard class driver (hereinafter, may be referred to as a “standard driver”) that can be used in common in printers supplied by different vendors. Such a standard driver is incorporated in the OS in advance. The standard driver can be used by connecting an arbitrary printer to a host computer having the OS in which the standard driver is incorporated. This enables to omit installation of the printer driver specific to the model. The standard driver can designate and use a print function in the printer in accordance with Print Device Capabilities (hereinafter referred to as “PDC”) generated on the basis of information obtained from the printer. This enables one standard driver to designate a print function for each printer. A function expansion application (hereinafter, may be referred to as “expansion application”) for expanding a function can be associated with the standard driver. The expansion application is provided by each vendor. Therefore, it is difficult to execute the function of the expansion application by the standard driver alone.

Japanese Patent Laid-Open No. 2021-33526 discloses an apparatus having a first application generating image data and a second application causing a user to perform a print setting used for printing the image data. The second application can set items that cannot be set by the first application. The items include an item to change an image size in accordance with printing in a predetermined standard such as poster printing or bookbinding printing.

However, the apparatus in the above publication is difficult to arbitrarily change the image size.

### SUMMARY

The present disclosure provides a mechanism capable of changing a scaling ratio used when a print data is scaled and printed with a printer by a numerical value.

Accordingly, an aspect of the present disclosure provides a non-transitory computer-readable storage medium storing a program supporting a general-purpose print software that generates print data printable by printers of a plurality of manufacturers and transmits the print data to a printer, the program causing a computer to execute a control method including displaying a setting accepting screen on which a scaling ratio used when the print data is scaled and printed with the printer is accepted by a numerical value, and transmitting numerical value information including the numerical value accepted on the setting accepting screen to the printer.

Features of the present disclosure will become apparent from the following description of embodiments with reference to the attached drawings. The following description of embodiments are described by way of example

### BRIEF DESCRIPTION OF THE DRAWINGS

FIG. 1 is a block diagram illustrating a hardware configuration of a print system according to a first embodiment.

FIG. 2A is a block diagram illustrating a general software configuration of a print system with which an expansion application is not associated.

FIG. 2B is a block diagram illustrating a software configuration of a print system with which the expansion application is associated.

FIG. 2C is a view illustrating print data before a scaling function is performed.

FIG. 2D is a view illustrating print data after an enlargement process is performed in a case where scaling ratios in a longitudinal direction and a lateral direction are the same.

FIG. 2E is a view illustrating print data after a reduction process is performed in a case where the scaling ratios in the longitudinal direction and the lateral direction are the same.

FIG. 2F is a view illustrating print data after the reduction process is performed in a case where the scaling ratios in the longitudinal direction and the lateral direction are different.

FIG. 3A is a view illustrating an example of a print setting screen displayed on a display unit of the print system.

FIG. 3B is a view illustrating an example of an advanced setting screen displayed when the expansion application is not associated.

FIG. 3C is a view illustrating an example of an advanced setting screen displayed when the expansion application is associated.

FIG. 3D is a view illustrating another example of the advanced setting screen displayed when the expansion application is associated.

FIG. 4 is a flowchart illustrating a process in which a print function expansion unit edits print function information.

FIG. 5 is a view illustrating an example of a list of capability information about a printer.

FIG. 6 is view illustrating an example of a list of print functions supported by the expansion application.

FIG. 7 is a view illustrating an example of a list of capability information about general-purpose print software.

FIG. 8 is a sequence chart illustrating a process executed among a drawing application, the general-purpose print software, the expansion application, and the printer after the drawing application accepts a print setting.

FIG. 9 is a block diagram illustrating a software configuration of a print system according to a second embodiment.

FIG. 10 is a flowchart illustrating a process in which a print function expansion unit edits print function information.

FIG. 11 is a view illustrating an example of a list of capability information about the printer.

FIG. 12 is a sequence chart illustrating a process executed among a drawing application, the general-purpose print software, the expansion application, and the printer after the drawing application accepts a print setting.

FIG. 13A is a view illustrating an example of an advanced setting screen displayed on a display unit of a print system according to a third embodiment.

FIG. 13B is view illustrating another example of the advanced setting screen displayed on the display unit of the print system according to the third embodiment.

FIG. 13C is view illustrating another example of the advanced setting screen displayed on the display unit of the print system according to the third embodiment.

FIG. 14A is view illustrating an example of an advanced setting screen displayed on a display unit of a print system according to a fourth embodiment.

FIG. 14B is a view illustrating another example of the advanced setting screen displayed on the display unit of the print system according to the fourth embodiment.

FIG. 14C is a view illustrating another example of the advanced setting screen displayed on the display unit of the print system according to the fourth embodiment.

FIG. 15A is a view illustrating an example of a print position of print data on a print sheet.

FIG. 15B is a view illustrating another example of the print position of the print data on the print sheet.

FIG. 16A is a view illustrating an example of a screen displayed on a display unit of a print system according to a fifth embodiment.

FIG. 16B is a view illustrating another example of the screen displayed on the display unit of the print system according to the fifth embodiment.

### DESCRIPTION OF THE EMBODIMENTS

Hereafter, embodiments according to the present disclosure will be described in detail by referring to the drawings. However, the configurations described in the following embodiments are merely examples, and the scope of the present disclosure is not limited by the configurations described in the embodiments. For example, each of the units constituting the present disclosure can be replaced with any unit that can exhibit the same function. In addition, an arbitrary constituent may be added. Any two or more configurations (features) of the embodiments can be combined.

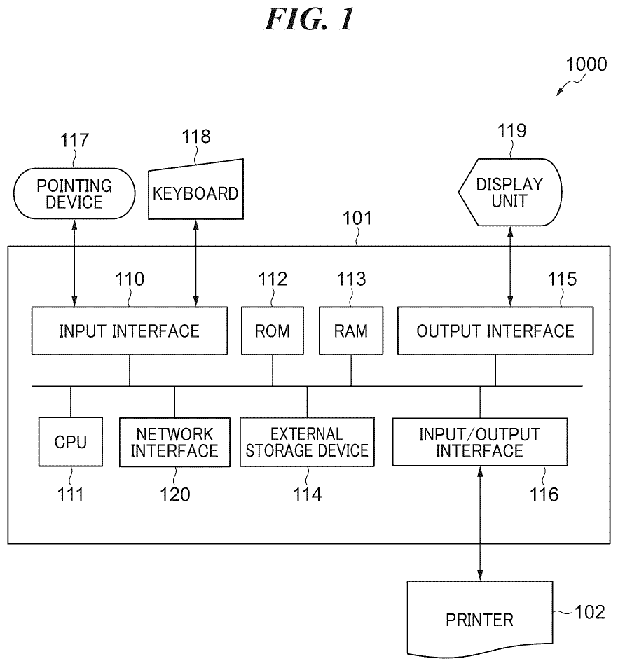

Hereinafter, the first embodiment will be described with reference to FIG. 1 to FIG. 8.

FIG. 1 is a block diagram illustrating a hardware configuration of a print system according to the first embodiment. As illustrated in FIG. 1, the print system 1000 includes a host computer 101, a printer 102, a pointing device 117, a keyboard 118, and a display unit 119, which are communicably connected to each other. The host computer 101 is an information processing apparatus and has an input interface 110, a CPU 111, a ROM 112, a RAM 113, an external storage device (storage medium) 114, an output interface 115, an input/output interface 116, and a network interface 120. The host computer 101 is, for example, a desktop personal computer, a notebook personal computer, a tablet terminal, a smartphone, or the like.

The CPU 111 is a computer that executes a program stored in the ROM 112 or the external storage device 114. The ROM 112 stores an initialization program. The external storage device 114 stores an application program group, an operating system (OS), print data generation software, and other various kinds of data. In the present embodiment, Windows (registered trademark) 11 of Microsoft (registered trademark) is installed in the host computer 101 as the OS.

The RAM 113 is used as a work memory when various programs stored in the external storage device 114 are executed so that the various programs can operate in the host computer 101. The input interface 110 is connected to the pointing device 117 and the keyboard 118 as input devices. The output interface 115 is connected to the display unit 119 as a display device. For example, a print setting screen 300A or an advanced setting screen 300C, which will be described later, is displayed on the display unit 119.

The network interface 120 controls data transfer with an external apparatus via a network. The printer 102 is connected to the input/output interface 116. The host computer 101 can communicate with the printer 102 regardless of a manufacturer of the printer 102, that is, information can be processed between the host computer and a plurality of printers of a plurality of manufacturers.

The printer 102 is, for example, a multi-function peripheral (MFP) having a plurality of functions such as copying, printing, and FAX, but this is not limited. In addition, the printer 102 employs an electrophotographic printing system in the present embodiment, but this is not limited, and may employ an inkjet printing system. Although the host computer 101 and the printer 102 are configured as separate devices in the present embodiment, this is not limited. For example, the host computer 101 and the printer 102 may be configured as an integrated device.

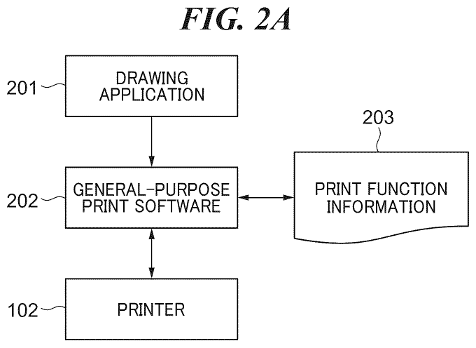

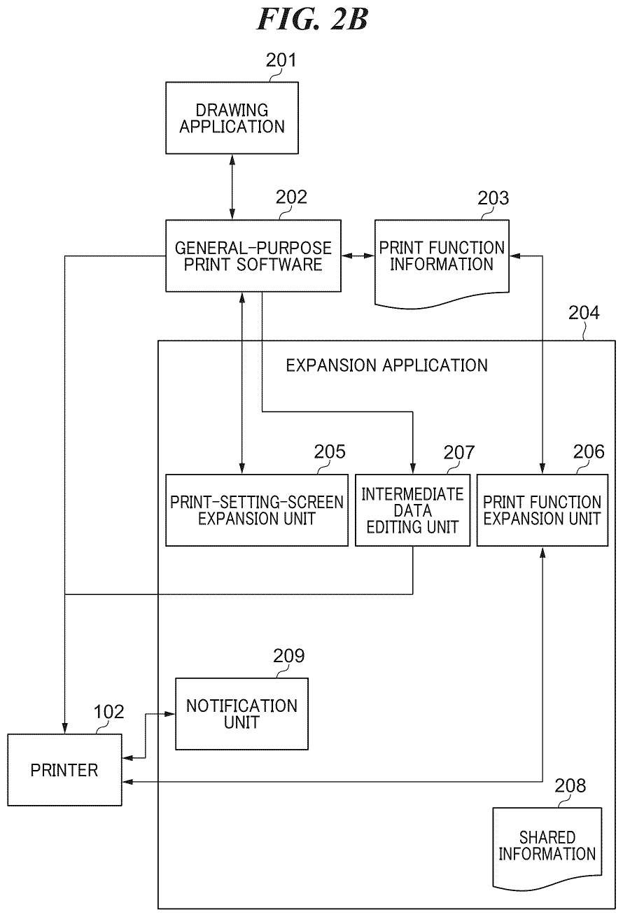

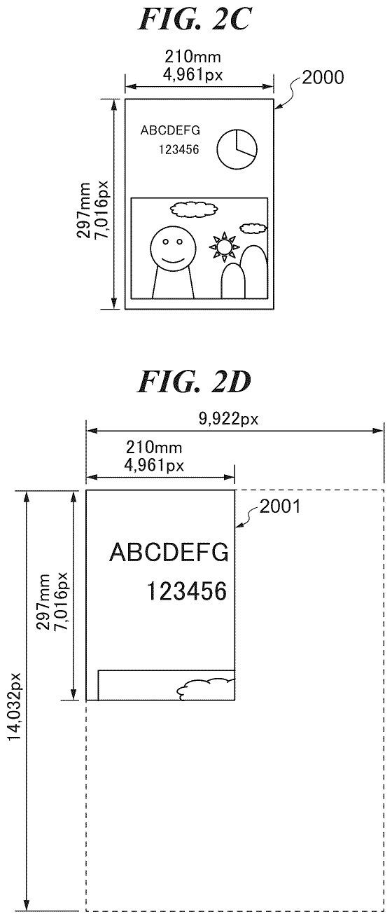

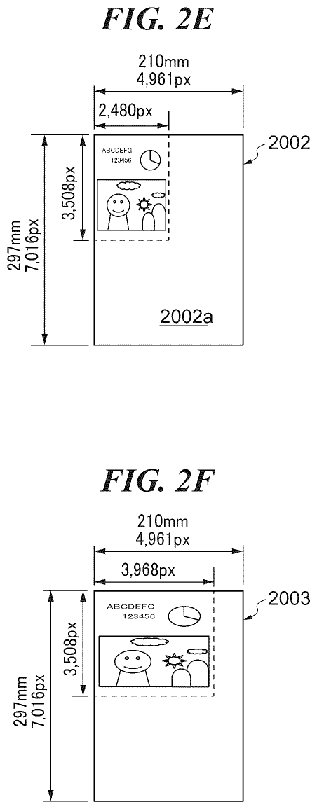

FIG. 2A and FIG. 2B are block diagrams illustrating software configurations of the print system. FIG. 2A is the diagram illustrating a general configuration in a case where there is no expansion application (program) that is associated with general-purpose print software (general program) 202 and the printer 102. FIG. 2B is the diagram illustrating a configuration in a case where there is an expansion application 204 that is associated with the general-purpose print software 202 and the printer 102.

The general-purpose print software 202 is a program that generates data printable by printers of a plurality of manufacturers, that is, a program that can be commonly used for the printers of the plurality of manufacturers in printing. The general-purpose print software 202 is installed in the OS in advance. In addition, the general-purpose print software 202 can transmit the print data generated by the general-purpose print software 202 to the printer 102. The general-purpose print software 202 is a program that operates based on the IPP (Internet Printing Protocol).

The expansion application 204 is a program that supports, i.e., supplements, the general-purpose print software 202. Although the expansion application 204 is an expanded program (a program that executes a control method) that is capable of expanding a function that is not executable on the printer 102 by the general-purpose print software 202 in the present embodiment, this is not limited. For example, the expansion application 204 may improve convenience of a function that is executable by the general-purpose print software 202 with respect to the printer 102. The expansion application 204 is stored in the external storage device 114 together with the OS including the general-purpose print software 202, for example. As a result, the host computer 101 has the general-purpose print software 202 and the expansion application 204.

First, the configuration in the case where there is no expansion application that is associated with the general-purpose print software 202 and the printer 102 will be described with reference to FIG. 2A. A drawing application 201 is software to generate a content (print data) to be printed by the printer 102. The drawing application 201 is not particularly limited, and may be a document creation application or a spreadsheet application.

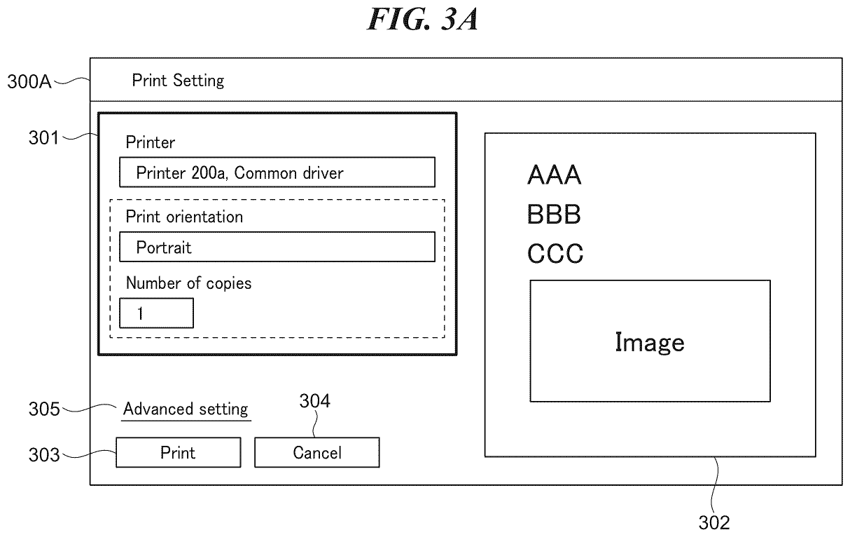

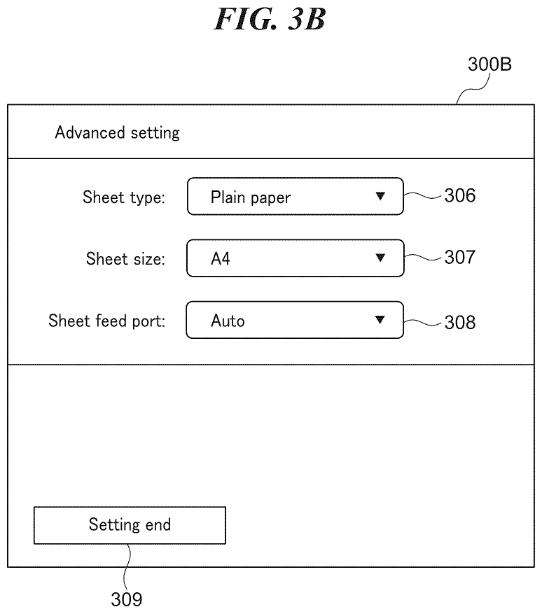

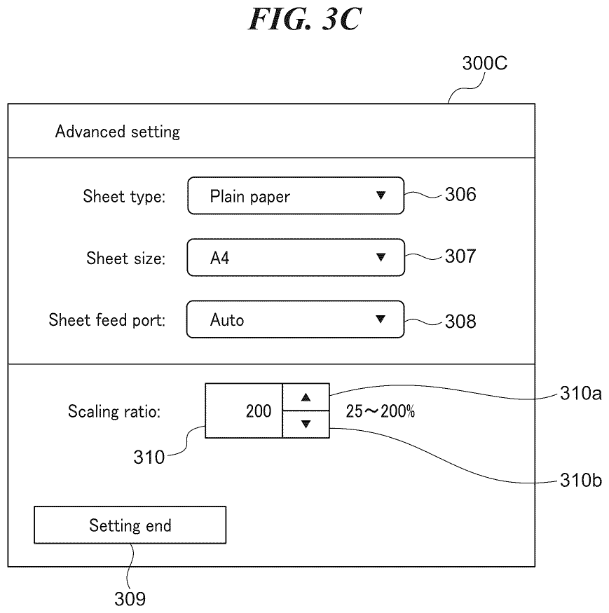

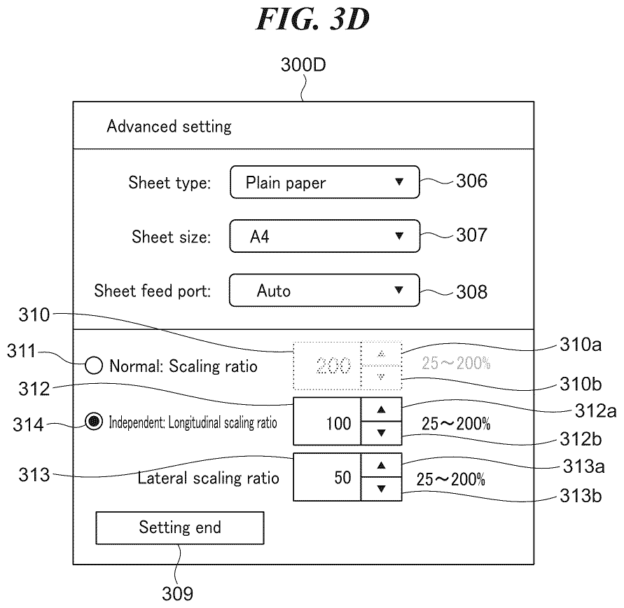

The drawing application 201 issues a print instruction to the OS when receiving a print request from a user via the keyboard 118, for example. The print instruction includes print setting information to instruct operations of the general-purpose print software 202 and the printer 102. The print setting information is also referred to as a “Print Ticket (PT)”. In addition, the drawing application 201 can display a print setting screen 300A (see FIG. 3A) provided by any one of the general-purpose print software 202, the OS, and the drawing application 201 on the display unit 119 in order to output the print setting information. When a control 305 in the print setting screen 300A is operated (pressed), an advanced setting screen 300B (see FIG. 3B) or the advanced setting screen 300C (see FIG. 3C) can be displayed on the display unit 119.

On the print setting screen 300A, setting items indicating settable print functions and control items indicating set values thereof are displayed in accordance with capability information obtained from the general-purpose print software 202, that is, information settable as print settings. The capability information relates to a print capability of the printer 102 and is also referred to as print capabilities (hereinafter, may be referred to as “PC”). It is also possible to determine whether the capability information includes information that enables to display the advanced setting screen 300C (a determination step). Then, as a result of this determination, when it is determined that the information that enables to display the advanced setting screen 300C is included, the advanced setting screen 300C can be displayed. On the other hand, when it is determined that the information that enables to display the advanced setting screen 300C is not included, the advanced setting screen 300C is not displayed. Details of the print setting screen 300A and the advanced setting screens 300B and 300C will be described later.

The general-purpose print software 202 determines the PC based on print function information 203. The print function information 203 is data indicating all the settable print functions, the set values thereof, and the print functions in which the exclusive relationship between the set values is described. The print function information 203 is also referred to as PDC (Print Device Capabilities). The print function information 203 is included in the configuration file of the general-purpose print software 202 and is arranged in the external storage device 114 as an unchangeable file. Alternatively, the print function information 203 may be dynamically generated by the general-purpose print software 202. Specifically, the general-purpose print software 202 obtains attribute data of the printer 102 from the printer 102. The general-purpose print software 202 generates the print function information 203 based on attribute information in the attribute data. When the print function information 203 is dynamically generated in this manner, the print function information 203 can be edited.

The attribute data of the printer 102 is a response obtained by issuing a “Get-Printer-Attributes” operation of the IPP to the printer 102. The response includes the attribute information indicating functions that can be designated in the printer 102, that is, the capability of the printer 102, and set values related to the attribute information. The response is stored in the RAM 113.

With this configuration, the general-purpose print software 202 can be configured so that the user can designate print functions available in the printer 102 in accordance with the printer 102 connected to the general-purpose print software 202. This enables to designate a print function available in a printer regardless of a model of the printer connected to the general-purpose print software 202, that is, even when a printer having a different function or a printer developed by a different printer manufacturer is connected.

In the present embodiment, the general-purpose print software 202 shall use an “IPP Class Driver” installed in Windows (registered trademark) 11. The “IPP Class Driver” is a printer driver that executes a print process in accordance with the specification of the standard print protocol called IPP and is included in the package of the OS. The “IPP Class Driver” is not a unique printer driver corresponding to the model of the printer 102, but is a standard Class Driver that can be commonly used in printers manufactured by a plurality of printer manufacturers regardless of a printer manufacturer. The “IPP Class Driver” obtains the capability information about the printer 102 and generates the print function information 203 based on the capability information.

Also, the general-purpose print software 202 may be associated with the expansion application 204. This enables the general-purpose print software 202 to execute a function that is not included in the general-purpose print software 202. For example, the IPP Class Driver (general-purpose print software 202) cannot execute a function of receiving a numerical value of a print scaling ratio used when the printer 102 prints the print data while enlarging or reducing, that is, a scaling ratio used when the print data is scaled and printed. Hereinafter, the function of receiving a numerical value of a scaling ratio is referred to as a “scaling function” or a “scaling process”.

As described above, the IPP Class Driver does not support execution of the scaling function for the printer 102. This is because the scaling function is a unique function executed by a printer manufactured by a predetermined printer manufacturer. The expansion application 204 can expand the function of the IPP Class Driver so as to execute the scaling function that cannot be executed by the IPP Class Driver solely. In the present embodiment, the IPP Class Driver cannot execute the scaling function, and the expansion application 204 can expands so as to execute the scaling function, but this is not limited. For example, the IPP Class Driver may perform a part of the scaling function, and the expansion application 204 may make up for a shortage of the scaling function to further expand a range of execution.

As described above, the scaling function allows to receive a scaling ratio as a numerical value when the printer 102 prints print data while scaling. Examples of use of the scaling function include a case where only a part of a document is enlarged and printed on an entire print sheet, a case where a document is reduced and a margin in a print sheet is taken a little more, and the like. The “scaling ratio” can be expressed by equation (1).

$$Scaling ratio ( \% ) = \frac{Longitudinal image size after scaling}{Longitudinal image size before scaling} \times 100 \qquad ( 1 )$$

The equation (1) indicates that the “scaling ratio” is an enlargement ratio or a reduction ratio in the longitudinal direction of the image before and after executing the scaling function. In this case, an aspect ratio in enlarging or reducing the image is constant. A case where the aspect ratio changes will be described later. For example, when the image size in the longitudinal direction and the lateral direction is enlarged twice, the numerical value “200%” should be designated as the scaling ratio. The scaling ratio here is the enlargement ratio or the reduction ratio in the longitudinal direction of the image before and after executing the scaling function, but this is not limited. For example, the scaling ratio may be an enlargement ratio or a reduction ratio in the lateral direction of the image before and after executing the scaling function, or may be an enlargement ratio or a reduction ratio in square measure of the image before and after executing the scaling function.

As a first execution example of the scaling function, a case where a longitudinal size and a lateral direction size of print data that has been converted into raster data is enlarged or reduced based on a numerical value of the scaling ratio and the print data is printed on a print sheet will be described. First, the longitudinal and lateral direction sizes (pixels (hereinafter referred to as “px”)) of the print data after the scaling process based on a scaling ratio are calculated. Next, an enlargement/reduction process is executed so that the print data becomes the calculated sizes (px) using an enlargement/reduction algorithm described later. Then, the print data after executing the enlargement/reduction process is printed on a print sheet. Although the case where the enlargement/reduction process is applied to the raster image data is described here, this is not limited. For example, raster image data that has been subjected to the enlargement/reduction process may be obtained by performing a rendering process after applying the enlargement/reduction process to vector image data. As described above, the scaling function in the present embodiment is only required to print the print data, which is enlarged or reduced as the scaling ratio, on a print sheet.

The enlargement/reduction algorithm is not particularly limited, and may be an algorithm capable of enlarging or reducing the longitudinal and lateral direction sizes (px) of print data before the scaling process to any sizes (px). Such an algorithm may be a bicubic method, a nearest neighbor method, a bilinear method, or the like. There is also an enlargement/reduction algorithm that increases the accuracy of either enlargement or reduction. Further, an enlargement algorithm and a reduction algorithm that are mutually different may be used for enlargement and reduction.

FIG. 2C to FIG. 2F are views showing an outline of execution of the scaling function. As shown in FIG. 2C, a sheet size of a print sheet 2000 is a format A4. The print sheet 2000 matches print data before executing the scaling function of which a size in a longitudinal direction is 7016 px and a size in a lateral direction is 4961 px. A case in executing the scaling function under such a condition will be described. The scaling ratio in the scaling function is 200% for enlargement printing and 50% for reduction printing. The size of the print data in the longitudinal direction after executing the scaling function (longitudinal size (px) of print data after scaling) can be expressed by equation (2). Further, the size of the print data in the lateral direction after executing the scaling function (lateral direction size (px) of print data after scaling) can be expressed by equation (3).

$$Longitudinal size ( px ) of print data after scaling = Longitudinal Size ( px ) of print data before scaling \times \frac{Scaling ratio ( \% )}{100} \qquad ( 2 )$$

$$Lateral size ( px ) of print data after scaling = Lateral size ( px ) of print data before scaling \times \frac{Scaling ratio ( \% )}{100} \qquad ( 3 )$$

As described above, the scaling ratio is the enlargement ratio or the reduction ratio in the longitudinal direction of the image before and after executing the scaling function, and the aspect ratio in enlarging or reducing the image is constant. When the scaling ratio is 200%, the size in the longitudinal direction becomes 14032 px=7016 px×200%/100 according to the equation (2), and the size in the lateral direction becomes 9922 px=4961 px×200%/100 according to the equation (3). Next, the enlargement process is executed on the print data by using the enlargement/reduction algorithm according to the size in the longitudinal direction obtained by the equation (2) and the size in the lateral direction obtained by the equation (3). Next, as shown in FIG. 2D, the print data after the enlargement process is printed on print sheet. In such printing, the upper left corner of the print data after the enlargement process is positioned at the upper left corner of a print sheet 2001. Accordingly, since the size of the enlarged print data is larger than the print sheet 2001 (7016 px×4961 px) of the format A4, only the image area that fits in the print sheet 2001 is printed on the print sheet 2001.

When the scaling ratio is 50%, the size in the longitudinal direction becomes 3508 px=7016 px×50%/100 according to the equation (2), and the size in the lateral direction is 2480 px=4961 px×50%/100 according to the equation (3). Next, the reduction process is executed on the print data by using the enlargement/reduction algorithm according to the size in the longitudinal direction obtained by the equation (2) and the size in the lateral direction obtained by the equation (3). Next, as shown in FIG. 2E, the print data after the reduction process is printed on a print sheet 2002. In such printing, the upper left corner of the print data after the reduction process is positioned at the upper left corner of the print sheet 2002. Accordingly, since the size of the print data after the reduction is smaller than the print sheet 2002 of the format A4, a margin 2002a is generated on the lower right of the print sheet 2002.

As a second execution example of the scaling function, an independent scaling function in which the aspect ratio of the print data changes due to the execution of the scaling process will be described. In the independent scaling function, unlike the first execution example of the scaling function, the scaling ratio (%) in the longitudinal direction (longitudinal scaling ratio) and the scaling ratio (%) in the lateral direction (lateral direction scaling ratio) can be individually set. Here, a case where the scaling ratio in the longitudinal direction is 50% and the scaling ratio in the lateral direction is 80% will be described. The size (px) of the print data in the longitudinal direction after executing the scaling function can be expressed by equation (4). Further, the size (px) of the print data in the lateral direction after executing the scaling function can be expressed by equation (5).

$$Longitudinal size ( px ) of print data after scaling = Longitudinal Size ( px ) of print data before scaling \times \frac{Longitudinal s caling ratio ( \% )}{100} \qquad ( 4 )$$

$$Lateral size ( px ) of print data after scaling = Lateral Size ( px ) of print data before scaling \times \frac{Lateral scaling ratio ( \% )}{100} \qquad ( 5 )$$

When the scaling ratio in the longitudinal direction is 50%, the size in the longitudinal direction becomes 3508px=7016px×50%/100 according to the equation (4). When the scaling ratio in the lateral direction is 80%, the size in the lateral direction becomes 3968px=4961px×80%/100 according to the equation (5). Next, the scaling process is executed on the print data using the enlargement/reduction algorithm according to the longitudinal size obtained by the equation (4) and the lateral direction size obtained by the equation (5). Next, as shown in FIG. 2F, the print data after the enlargement process is printed on a print sheet 2003. In such printing, since the scaling ratio (80%) in the lateral direction is larger than the scaling ratio (50%) in the longitudinal direction, the print data after the scaling is printed as an image as if the image is extended in the lateral direction of the print sheet 2003.

When the independent scaling function is executed, the scaling ratio in the longitudinal direction and the scaling ratio in the lateral direction are set to be less than 100%, that is, the numerical values suitable for the reduction printing are set, in this example, but this is not limited. For example, the scaling ratio in the longitudinal direction and the scaling ratio in the lateral direction may be set to exceed 100%, that is, the numerical values suitable for the enlargement printing may be set. Alternatively, one of the scaling ratio in the longitudinal direction and the scaling ratio in the lateral direction may be set to be less than 100% and the other may be set to exceed 100%.

Now, the description will return to the description referring to FIG. 2A. The OS generates intermediate data (may be referred to as “input data”) based on the print instruction output from the drawing application 201, and transmits the intermediate data to the general-purpose print software 202. The data output for printing by the drawing application 201 is not particularly limited, and is preferably, for example, a data in an XML Paper Specification format (XPS format). The data output for printing by the drawing application 201 may be data in a Graphic Device Interface format (GDI format). In a case where the IPP Class Driver is used as the general-purpose print software 202, if the data output by the drawing application 201 is GDI format data, the OS converts the GDI format data into XPS format data. Then, the OS transmits the converted XPS format data to the general-purpose print software 202 as the intermediate data.

In addition, when the data output by the drawing application 201 is data in the XPS format, the OS transmits the data in the XPS format to the general-purpose print software 202 as the intermediate data. The intermediate data includes drawing data that is information about characters and figures formed on a print medium, and print setting information set by the user.

The general-purpose print software 202 converts the intermediate data into printable data (image data) that can be processed by the printer 102, and transmits the print data to the printer 102. Here, the “print data” in the present embodiment is PDL (Page Description Language) data conforming to the IPP. The PDL data is, for example, data in a PDF (Portable Document Format) or a PWG-Raster format. The print data includes drawing data that is information about characters and figures formed on a print sheet (print medium), and print setting attribute information that is generated based on the print setting information set by the user and designates the print setting. The print setting attribute information includes attribute information indicating a function that can be designated in the printer 102, that is, the capability of the printer 102, and a set value related to the attribute information.

The printer 102 prints an image on a print sheet based on the print data sent from the general-purpose print software 202. At this time, the printer 102 can form the drawing data included in the print data on the print sheet by performing an operation according to the print setting attribute information included in the print data. The print setting attribute information includes, for example, a print quality, such as image quality priority or speed priority, attribute information for designating two-sided printing or one-sided printing, and the set value of the attribute information. For example, when the print setting attribute information includes attribute information designating the two-sided printing, the printer 102 can execute the two-sided printing.

The case where the expansion application 204 is associated with the general-purpose print software 202 and the printer 102 will be described with reference to FIG. 2B. As shown in FIG. 2B, unlike FIG. 2A, the expansion application 204 is added. That is, the host computer 101 includes the drawing application 201, the general-purpose print software 202, the print function information 203, and the expansion application 204.

The expansion application 204 is software to expand the function of the general-purpose print software 202. The expansion application 204 is software that is not included in the OS in advance (not packaged together). Therefore, the expansion application 204 is downloaded from a server (not shown) via the Internet and installed in the host computer 101 by the user operating the host computer 101. Alternatively, the expansion application 204 may be automatically installed in the host computer 101 when the printer 102 is connected to the host computer 101.

Specifically, when the printing apparatus 102 is connected to the host computer 101, the OS obtains the device identification information from the printer 102. The OS may download the expansion application 204 corresponding to the device identification information from the server via the Internet and install the expansion application 204. As a result, the general-purpose print software 202 and the expansion application 204 are held as different control programs in the host computer 101.

The general-purpose print software 202 and the expansion application 204 may be updated and upgraded. In this case, the update process of the general-purpose print software 202 and the update process of the expansion application 204 may be performed at the same timing or may be performed at different timings. A trigger to obtain the general-purpose print software 202 and a trigger to obtain the expansion application 204 by the host computer 101 may be the same or different. In addition, when the expansion application 204 is installed, the OS associates the expansion application 204 with the general-purpose print software 202 and the printer 102.

As illustrated in FIG. 2B, the expansion application 204 can exchange information (transmit and receive information) with the general-purpose print software 202 and the printer 102. That is, the expansion application 204 is associated with the general-purpose print software 202 and the printer 102. In the present embodiment, the expansion application 204 includes a print-setting-screen expansion unit 205, a print function expansion unit 206, an intermediate data editing unit 207, and a notification unit 209. The expansion application 204 includes a shared information 208 that can be accessed from each of the print-setting-screen expansion unit 205, the print function expansion unit 206, the intermediate data editing unit 207, and the notification unit 209. The shared information 210 is a file stored in the external storage device 114 or information stored in the RAM 113. The expansion application 204 can write and read the shared information 208 by using an API (Application Program Interface) provided by the OS.

The expansion application 204 may end the operation of the expansion application 204 as a whole in accordance with the end of the process of each of the print-setting-screen expansion unit 205, the print function expansion unit 206, the intermediate data editing unit 207, and the notification unit 209. In this case, the OS 213 activates the expansion application 204 whenever a process execution request is received from each unit. In addition, the OS terminates the operation of the expansion application 204 as a whole, for example, in a case where the process of the print-setting-screen expansion unit 205 ends.

In addition, the expansion application 204 may cancel the process during the process of each of the print-setting-screen expansion unit 205, the print function expansion unit 206, the intermediate data editing unit 207, and the notification unit 209. In this case, the OS deletes a job in processing on a print queue. As described above, the drawing application 201 issues a print instruction to the OS in response to a print request from a user. In addition, the drawing application 201 can also display a print setting screen. In the configuration shown in FIG. 2B, the drawing application 201 can display the print setting screen 300A (an advanced setting screen 300C) provided by the print-setting-screen expansion unit 205 (the expansion application 204). The print-setting-screen expansion unit 205 can store an advanced setting set by the user in the shared information 208. The print-setting-screen expansion unit 205 will be described in detail later.

The intermediate data editing unit 207 obtains the intermediate data from the general-purpose print software 202. Then, the intermediate data editing unit 207 converts the intermediate data into the print data and then transmits the print data to the printer 102. The intermediate data editing unit 207 obtains advanced setting information from the shared information 208 and adds the advanced setting to the print data. The printer 102 prints an image on a paper sheet based on the print data from the intermediate data editing unit 207.

The expansion application 204 may be configured to obtain print data generated by the general-purpose print software 202 and add the advanced setting to the print data. In addition, even in the configuration in FIG. 2B, the scaling function may not be executed. In this case, the general-purpose print software 202 may transmit the print data to the printer 102 without passing through the expansion application 204.

The print function expansion unit 206 can edit the print function information 203 (PDC) generated by the general-purpose print software 202 or the OS. This enables addition of a function provided by the expansion application 204. In addition, a function (for example, scaling function) that can be executed by the printer 102 but cannot be executed by the general-purpose print software 202 can be added, and an exclusive relationship between setting values of print functions can be added.

The OS activates the print function expansion unit 206 when the expansion application 204 is associated with the printer 102 and the general-purpose print software 202 at first. Further, the OS may activate the print function expansion unit 206 at other timings (for example, at the time of activation of the OS). By such activation, even when the function related to printing is expanded later, the print function expansion unit 206 can detect the expanded function and add the expanded function to the print function information 203. As an example in which the function related to printing is expanded later, there is a case where an optional device (for example, a finisher) is added to the printer 102 later.

When an error occurs in the printer 102, the notification unit 209 can notify the user of the error. For example, when a no-sheet error occurs in the printer 102, the general-purpose print software 202 detects the occurrence of the error. The OS displays the occurrence of the no-sheet error, which is the detection result of the general-purpose print software 202, as a message on the display unit 119 by a notification function called toast notification, which is one of the functions of the OS. When the user operates the toast notification, the notification unit 209 is called by the OS, and the user interface screen (UI screen) of the notification unit 209 is displayed. On the user interface screen, for example, a detailed message related to the no-sheet error and a sheet replenishing method can be displayed.

As described above, in the present embodiment, the expansion application 204 has the following four functions. The first is a function of displaying a setting screen. This function is performed by the print-setting-screen expansion unit 205. The second is a function of editing the intermediate data to convert the intermediate data into the print data and adding the advanced setting to the print data. This function is performed by the intermediate data editing unit 207. The third is a function of expanding a function that can be designated by the print data generation software. This function is performed by the print function expansion unit 206. The fourth is a function of displaying a screen in response to occurrence of an error in the printer 102. This function is performed by the notification unit 209.

The configuration of the expansion application 204 is not limited to the configuration having all the functions described above. The expansion application 204 preferably has at least one of the functions, and may have another function. In addition, once the expansion application 204 transmits the print data to the printer 102, the expansion application 204 cannot display a screen such as a guide associated with the print data during a process of each unit.

FIG. 3A to FIG. 3D are views illustrating examples of screens displayed on the display unit of the print system. FIG. 3A shows the print setting screen displayed by the drawing application 201. FIG. 3B shows the advanced setting screen that is displayed in a case where the expansion application 204 is not associated. FIG. 3C and FIG. 3D respectively show the advanced setting screens displayed in a case where the expansion application 204 is associated. Note that the units and modules that display the screens are not particularly limited. For example, the print-setting-screen expansion unit 205 may be configured to only generate the display screen. In this case, the print-setting-screen expansion unit 205 transmits the generated display screen to the drawing application 201 via the general-purpose print software 202. The drawing application 201 may be configured to display the obtained display screen.

The print setting screen 300A shown in FIG. 3A is the screen on which print conditions relating to printing by the printer 102 can be set. The print setting screen 300A includes controls (buttons) 301, 302, 303, 304, and 305. The control 301 allows a user to set a printer used for printing, a print orientation by the printer, and the number of copies to be printed by the printer. In FIG. 3A, the printer used for printing is set to “Printer 200a”, the print orientation by the printer is set to “Portrait”, and the number of copies to be printed by the printer is set to “1”, for example. In the control 302, a preview screen is displayed. The control 303 allows the user to instruct start of printing by the printer. The control 304 allows the user to instruct cancellation of printing by the printer 102. The control 305 allows the user of the advanced setting.

When the user operates the control 305 in the case where the expansion application 204 is not associated, the advanced setting screen 300B shown in FIG. 3B is displayed. The advanced setting screen 300B includes control 306, 307, 308, and 309. The controls 306 to 308 are arranged in a vertical direction on the upper side of the advanced setting screen 300B. The control 309 is located on a lower side of the advanced setting screen 300B.

The control 306 allows the user to select and set a sheet type (media type) to be used in printing by the printer 102. In FIG. 3B, “Plain paper” is selected as an example. The control 307 allows the user to select and set a sheet size used in printing by the printer 102. In FIG. 3B, “A4” is selected as an example. The control 308 allows the user to select a sheet feed port to be used in printing by the printer 102. In FIG. 3B, “Auto” is selected as an example. The control 309 allows the user to finish the settings in the controls 306 to 308. Further, when the user operates the control 309, the display returns to the print setting screen 300A shown in FIG. 3A.

When the user operates the control 305 in the case where the expansion application 204 is associated, an advanced setting screen (setting accepting screen) 300C shown in FIG. 3C or an advanced setting screen 300D shown in FIG. 3D is displayed (a display control step). First, the advanced setting screen 300C will be described. The advanced setting screen 300C is a screen displayed together with the print setting screen 300A, but its display mode is not particularly limited. For example, the advanced setting screen 300C may be displayed over the print setting screen 300A, the advanced setting screen 300C may be displayed adjacent to the print setting screen 300A, or the advanced setting screen 300C may be displayed after the print setting screen 300C disappears once.

The advanced setting screen 300C is used to accept the scaling ratio as a numerical value when the print data is scaled and printed by the printer 102. The advanced setting screen 300C includes the controls 306 to 309 as with the advanced setting screen 300B. Also, the advanced setting screen 300C includes a control 310 in addition.

The control 310 is an input box in which the scaling ratio is input as a numerical value. In the control 310, an up button 310a for raising, that is, increasing the numerical value in the control 310 and a down button 310b for lowering, that is, decreasing the numerical value are arranged vertically. Then, the user can set a desired size by appropriately pressing the up button 310a or the down button 310b to change the numerical value in the control 310 by 1%. In FIG. 3C, “200%” is set as an example.

A change width of the numerical value per one press operation on the up button 310a or the down button 310b is not limited to 1%, and may be 0.1%, for example. In addition, a numerical value range that can be input to the control 310 is defined. This enables the user to input a numerical value within a range in which the scaling function can be executed. In FIG. 3C, the numerical value range is defined as “25% to 200%” as an example, but this is not limited. Note that the control 310 is arranged below the control 308 in the configuration illustrated in FIG. 3C, but this is not limited.

Next, the advanced setting screen 300D will be described. The description will focus on differences from the advanced setting screen 300C described above, and the description of the same matters will be omitted. The advanced setting screen 300D corresponds to the execution of the independent scaling function. The advanced setting screen 300D includes the controls 306 to 310 as with the advanced setting screen 300C. In addition, the advanced setting screen 300D further includes controls 311, 312, 313, and 314.

The control 312 is an input box (a first input box) in which a longitudinal scaling ratio in the longitudinal direction of a print sheet on which print data is printed by the printer 102 is input as a numerical value. In the control 312, an up button 312a for increasing the numerical value in the control 312 and a down button 312b for decreasing the numerical value are arranged vertically. Then, the user can set a desired size by appropriately pressing the up button 312a or the down button 312b to change the numerical value in the control 312 by 1%. In FIG. 3D, “100%” is set as an example.

A change width of the numerical value per one press operation on the up button 312a or the down button 312b is not limited to 1%, and may be 0.1%, for example. In addition, a numerical value range that can be input to the control 312 is defined. This enables the user to input a numerical value within a range in the longitudinal direction in which the independent scaling function can be executed. In FIG. 3D, the numerical value range is defined as “25% to 200%” as an example, but this is not limited.

The control 313 is an input box (a second input box) in which a lateral scaling ratio in the lateral direction of a print sheet on which print data is printed by the printer 102 is input as a numerical value. In the control 313, an up button 313a for increasing the numerical value in the control 313 and a down button 313b for decreasing the numerical value are arranged vertically. Then, the user can set a desired size by appropriately pressing the up button 313a or the down button 313b to change the numerical value in the control 313 by 1%. In FIG. 3D, “50%” is set as an example.

A change width of the numerical value per one press operation on the up button 313a or the down button 313b is not limited to 1%, and may be 0.1%, for example. In addition, a numerical value range that can be input to the control 313 is defined. This enables the user to input a numerical value within a range in the lateral direction in which the independent scaling function can be executed. In FIG. 3D, the numerical value range is defined as “25% to 200%” as an example, but this is not limited.

A control 311 is a check box to be checked before the user inputs a numerical value to the control 310. A control 314 is a check box to be checked before the user inputs numerical values to the controls 312 and 313. In FIG. 3D, the control 314 is checked and the control 311 is not checked. In this state, the user can input numerical values to the controls 312 and 313, but is prohibited to input a numerical value to the control 310. The control 310 is displayed in a grayed-out manner. This visualizes that the input of a numerical value to the control 310 is prohibited. The user can recognize that the input of a numerical value to the control 310 is prohibited by visually recognizing the control 310 displayed in the gray-out manner.

Hereinafter, a reason why the items included in the advanced setting screen 300B shown in FIG. 3B are different from the items included in the advanced setting screens 300C shown in FIG. 3C and the items included in the advanced setting screen 300D shown in FIG. 3D will be described. The items included in the advanced setting screen 300C and the items included in the advanced setting screen 300D are the same except a numerical value entry mode for the scaling ratio. Therefore, the reason why the items included in the advanced setting screen 300B are different from the items included in the advanced setting screen 300C will be described as a representative example. The advanced setting screen 300B and the advanced setting screen 300C are generated based on the print capability information (capability information).

As described above, the general-purpose print software 202 does not support the execution of the scaling function. Therefore, the scaling function cannot be added to the print function information only by the general-purpose print software 202. In addition, even if the scaling function is originally included in the print function information, the general-purpose print software 202 cannot interpret the scaling function included in the print function information. Therefore, the setting of the scaling function cannot be displayed on the advanced setting screen. Therefore, the print function expansion unit 206 adds the scaling function to the print function information 203. Then, the print-setting-screen expansion unit 205 refers to the capability information and displays the advanced setting screen 300C. Accordingly, the expansion application 204 can display the setting of the scaling function on the advanced setting screen.

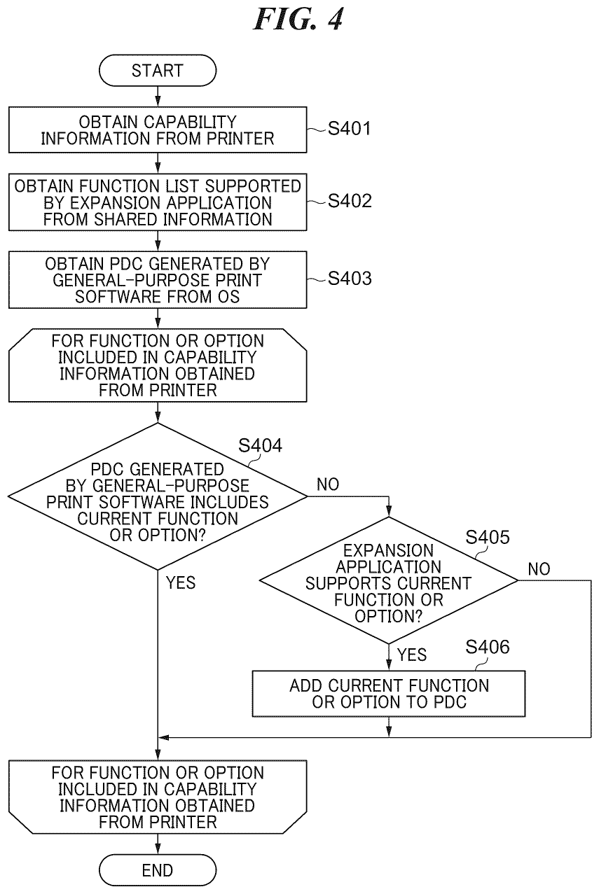

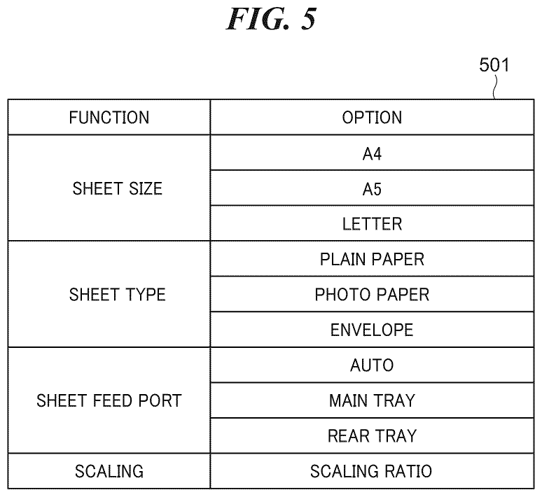

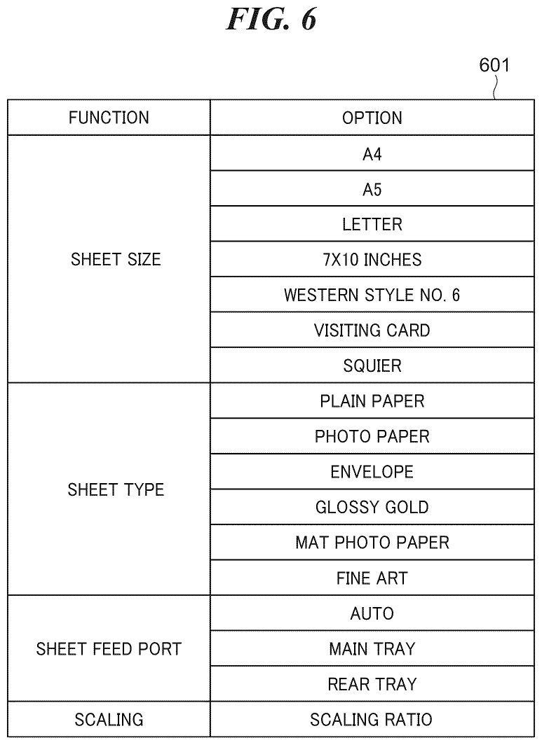

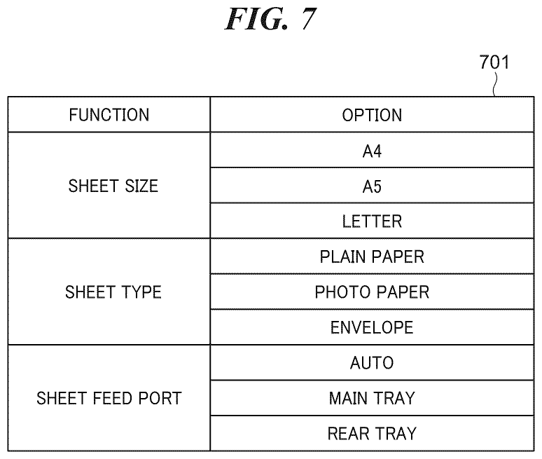

FIG. 4 is a flowchart illustrating a process in which a print function expansion unit edits the print function information. Note that a program based on the flowchart shown in FIG. 4 is executed by the CPU 111 controlling the print function expansion unit 206. FIG. 5 is a view illustrating an example of a list of capability information about the printer. FIG. 6 is view illustrating an example of a list of print functions supported by the expansion application. FIG. 7 is a view illustrating an example of a list of capability information about the general-purpose print software.

As shown in FIG. 4, the print function expansion unit 206 obtains the capability information from the printer 102 in a step S401 (an obtaining step) prior to the display control step described above. The capability information is a set value included in a response obtained by issuing a “Get-Printer-Attributes” operation of IPP to the printer 102. The set value relates to a function that can be designated in the printer 102 and its attribute information. A table 501 shown in FIG. 5 lists the capability information of the printer 102. The capability information includes, for example, information about a size of a sheet used in printing by the printer 102. In addition, there are information relating to sheet types (media types) used in printing by the printer 102, information relating to the sheet feed port used in printing by the printer 102, and information relating to the scaling function that can be executed by the printer 102.

In a step S402, the print function expansion unit 206 obtains the print function supported by the expansion application 204 from the shared information 208. The shared information 208 stores a list of print functions supported by the expansion application 204. The list includes all print functions that can be processed by the expansion application 204 and their set values. A table 601 shown in FIG. 6 includes information about sheet sizes supported by the expansion application 204 as a print function. In addition, there are information about the sheet types supported by the expansion application 204, information about the sheet feed port supported by the expansion application 204, and information about the scaling function supported by the expansion application 204. The print functions supported by the expansion application 204 may be updated according to update of the expansion application 204.

In a step S403, the print function expansion unit 206 obtains the print capability information (PDC) 203 generated by the general-purpose print software 202 from the OS. The print function information 203 is generated based on the capability information (see the table 501) obtained from the printer 102 by the general-purpose print software 202. The print function information (PDC) 203 generated by the general-purpose print software 202 includes only the print functions supported by the general-purpose print software 202 among the capability information obtained from the printer 102.

For example, the table 601 shown in FIG. 6 includes “7×10 inch” and “western style No. 6” as the sheet sizes. However, a table 701 shown in FIG. 7 does not includes these sizes that are not supported by the general-purpose print software 202. Therefore, the print function information 203 does not include the sheet sizes concerned. In addition, although the table 601 shown in FIG. 6 includes information about the scaling function, the table 701 shown in FIG. 7 does not include the scaling function that is not supported by the general-purpose print software 202. Therefore, the print function information 203 does not include the scaling function. The expansion application 204 can supply a function shortage of the general-purpose print software 202 by the print function expansion unit 206 adding a function or an option to the print function information 203. The print function expansion unit 206 can also delete an unnecessary function or option from the print function information 203 generated by the general-purpose print software 202.

Steps S404, S405, and S406 are processes that are repeatedly performed on the list of functions included in the capability information obtained from the printer 102 in the step S401. In the present embodiment, the steps S404, S405, and S406 are repeated for all ten options included in the table 501.

In the step S404, the print function expansion unit 206 determines whether the print function information 203 generated by the general-purpose print software 202 includes a function or an option currently processed. When it is determined in the step S404 that the function or option is included in the print capability information 203 and when the option currently processed is the last items of the options, the prosses in FIG. 4 ends. Alternatively, when the option currently processed is not the last item of the options, the next item of the options is selected and the process in the step S404 is performed again. On the other hand, when it is determined in the step S404 that the function or option currently processed is not included in the print function information 203, the process proceeds to the step S405.

For example, in the present embodiment, the table 501 includes the sheet size “A4”, and the table 701 also includes the sheet size “A4”. In this case, it is determined in the step S404 that the function or option currently processed is included in the print function information 203. In contrast, the table 501 includes the “scaling function”, but the table 701 does not include the “scaling function”. In this case, it is determined in the step S404 that the function or option currently processed does not included in the print function information 203.

In the step S405, the print function expansion unit 206 determines whether the functions or options supported by the expansion application 204 include the function or option currently processed. That is, it is determined whether the expansion application 204 supports the function or option currently processed. When it is determined in the step S405 that the expansion application supports the function or option currently processed, the process proceeds to the step S406. On the other hand, when it is determined in the step S405 that the expansion application 204 does not support the function or option currently processed, the process is terminated when the option currently processed is the last item of the options, as in the case where “Yes” is determined in the step S404. Alternatively, when the option currently processed is not the last item of the options, the next item of the options is selected and the process in the step S404 is performed again. For example, in the present embodiment, when the function currently processed is the “scaling function”, the “scaling function” is also included in the table 601. Therefore, it is determined in step S405 that there is the function currently processed.

In the step S406, the print function expansion unit 206 adds the currently processed function or option to the print function information 203. After the prosses in the step S406 is executed, when the option currently processed is the last item of the options, the process is terminated, as in the case where “Yes” is determined in the step S404. Alternatively, when the option currently processed is not the last item of the options, the next item of the options is selected and the process in the step S404 is performed again.

As described above, the expansion application 204 can add, to the print function information 203, a function or option that is not supported by the general-purpose print software 202, is supported by the printer 102 and the expansion application 204. Then, the capability information (PC) is generated based on the print function information 203 edited by the addition process. The print-setting-screen expansion unit 205 can display the advanced setting screen 300C or the advanced setting screen 300D by generating the display screen based on the capability information and expanding the function that is not supported by the general-purpose print software 202.

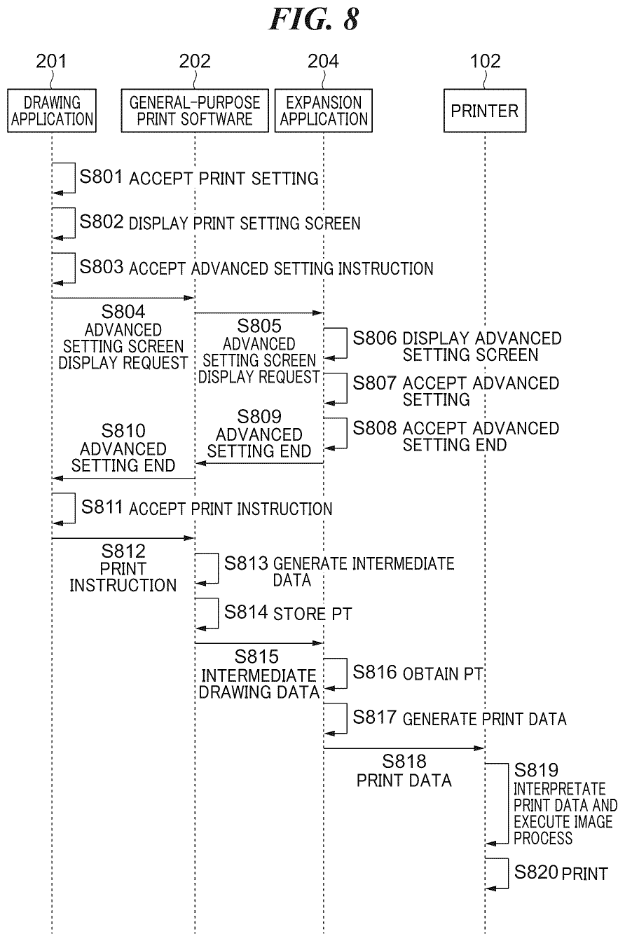

FIG. 8 is a sequence chart illustrating a process executed among the drawing application, the general-purpose print software, the expansion application, and the printer after the drawing application accepts a print setting. The processes of the drawing application, general-purpose print software, and expansion application are executed by the CPU 111 of the host computer 101. A process program is stored in the external storage device 114. Then, the CPU 111 reads the process program from the external storage device 114 to the RAM 113 and executes the process program. The process of the printer 102 is executed by a CPU (not shown) of the printer 102. Further, the print system 1000 has the software configuration shown in FIG. 2B.

As shown in FIG. 8, the drawing application 201 accepts a print setting by a user in a step S801. The user can instruct the drawing application 201 to execute the print setting by operating, for example, the pointing device 117 or the keyboard 118.

In a step S802, the drawing application 201 displays the print setting screen 300A shown in FIG. 3A on the display unit 119.

In a step S803, the drawing application 201 receives an advanced setting instruction by the user. The user can instruct the advanced setting by selecting the control 305 on the print setting screen 300A by operating, for example, the pointing device 117 or the keyboard 118.

In a step S804, the drawing application 201 requests the general-purpose print software 202 to display the advanced setting screen.

In a step S805, the general-purpose print software 202 requests the expansion application 204 to display the advanced setting screen.

In a step S806, the print-setting-screen expansion unit 205 of the expansion application 204 displays the advanced setting screen 300C shown in FIG. 3C. As described above, the print function expansion unit 206 adds the scaling function to the print function information 203 (PDC). The print-setting-screen expansion unit 205 can display the advanced setting screen 300C by referring to the capability information (PC) generated based on the added print capability information 203.

In a step S807, the print-setting-screen expansion unit 205 receives the advanced setting on the advanced setting screen 300C by the user. In this example, the sheet type “plain paper” shall be selected in the control 306, the paper size “A4” shall be selected in the control 307, and the paper feed port “auto” shall be selected in the control 308 on the advanced setting screen 300C as shown in FIG. 3C. The scaling ration “200%” shall be input in the control 310. In this setting state, the print-setting-screen expansion unit 205 accepts the operation of the control 309 on the advanced setting screen 300C by the user.

In a step S808, the print-setting-screen expansion unit 205 accepts the end of the advanced setting by the user based on the operation of the control 309 in the step S807. The user can instruct the end of the advanced setting by selecting the control 309 by, for example, operating the pointing device 117 or the keyboard 118.

In a step S809, the expansion application 204 transmits advanced setting end information indicating the end of the advanced setting accepted in the step S808 to the general-purpose print software 202.

In a step S810, the general-purpose print software 202 receives the advanced setting end information transmitted from the expansion application 204 in the step S809. The general-purpose print software 202 transmits the advanced setting end information to the drawing application 201.

In a step S811, the drawing application 201 accepts a print instruction by the user. The user can issue the print instruction by selecting the control 303 on the print setting screen 300A (see FIG. 3A) by operating, for example, the pointing device 117 or the keyboard 118.

In a step S812, the drawing application 201 transmits the print instruction accepted in the step S811 to the general-purpose print software 202.

In a step S813, the general-purpose print software 202 generates intermediate data based on the print instruction received in the step S812 using a module of the OS.

In a step S814, the general-purpose print software 202 stores the print setting information (PT) based on the print instruction received in the step S812 in the shared information 208.

In the step S815, the general-purpose print software 202 transmits the drawing data among the intermediate data generated in the step S813 to the expansion application 204.

In a step S816, the intermediate data editing unit 207 of the expansion application 204 obtain the print setting information stored in the step S814 from the shared information 208.

In a step S817, the intermediate data editing unit 207 of the expansion application 204 generates print data using the drawing data transmitted in the step S815 and the print setting information obtained in the step S816. The print data includes the numerical value (numerical value information) of the scaling ratio accepted on the advanced setting screen 300C.

In a step S818, the intermediate data editing unit 207 of the expansion application 204 transmits the print data generated in the step S817 to the printer 102 (a transmission step). As described above, the print data includes numerical value information about the scaling ratio accepted on the advanced setting screen 300C.

In a step S819, the printer 102 receives the print data transmitted in the step S818. The printer 102 interprets the print data and applies a necessary image process to the print data. The image process applied in this step scales the print data based on the numerical value information about the scaling ratio transmitted in the step S818.

In a step S820, the printer 102 prints the print data that is subjected to the image process in the step S819. As a result, a printed sheet on which the print data that is scaled to the scaling ratio accepted on the advanced setting screen 300C is obtained.

As described above, the expansion application 204 in the print system 1000 can display the advanced setting screen 300C shown in FIG. 3C even when the general-purpose print software 202 does not support the scaling function. In the advanced setting screen 300C, the scaling ratio used when the printer 102 scales and prints print data can be changed with a numerical value. Then, the printer 102 may execute the scaling function based on the scaling ratio (numerical value information) accepted on the advanced setting screen 300C. As a result, the printer 102 prints the print data scaled by the scaling ratio on the print sheet.

The description referring to FIG. 8 assumes that the print system 1000 employs the software configuration shown in FIG. 3B and displays the advanced setting screen 300C shown in FIG. 3C, but this is not limited. For example, when the general-purpose print software 202 is requested to display the advanced setting screen in the step S804, the general-purpose print software 202 displays the advanced setting screen 300B shown in FIG. 3B. In this case, the general-purpose print software 202 requests the expansion application 204 to display an additional advanced setting screen when the control 309 on the advanced setting screen 300B is operated. The expansion application 204 may then display the additional advanced setting screen on which the scaling function can be set. In addition, the expansion application 204 generates the print data from the intermediate data generated by the general-purpose print software 202 in the present embodiment, but this is not limited. For example, the expansion application 204 itself may generate the intermediate data.

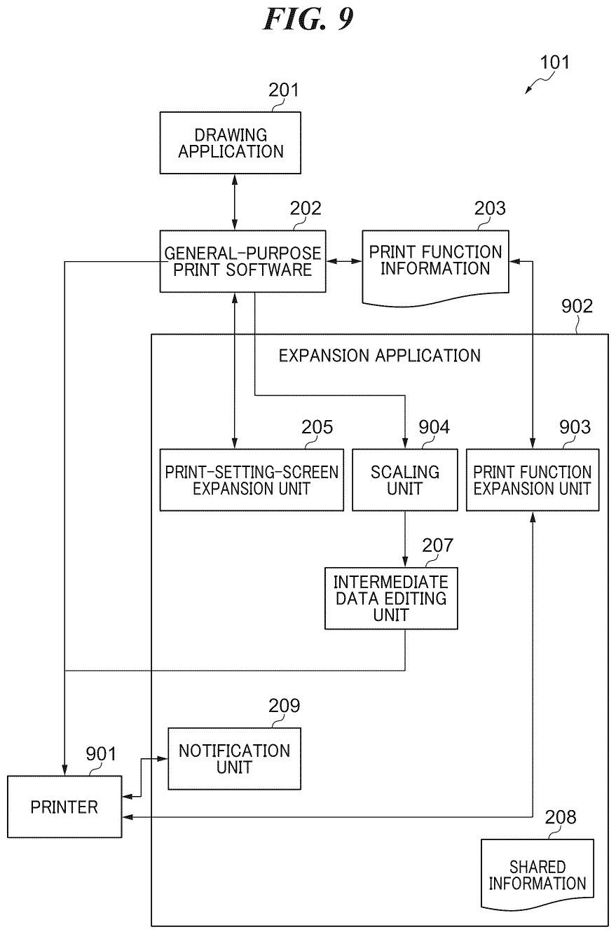

Hereinafter, a second embodiment will be described with reference to FIG. 9 to FIG. 12. Differences from the above-described embodiment will be mainly described, and the descriptions of the same matters will be omitted. In first embodiment, the expansion application 204 generates the print data including the scaling ratio together with the general-purpose print software 202. This print data is transmitted to the printer 102. The printer 102 can interpret the print data including the scaling ratio and execute the scaling function. In this way, the expansion application 204 causes the printer 102 to execute the scaling function together with the general-purpose print software 202 in the first embodiment.

However, there is a case where a printer cannot execute the scaling function. In this case, even if the expansion application generates the print data including the scaling ratio, the printer cannot execute the scaling function. When the printer cannot execute the scaling function, it is preferable that the expansion application generates print data by executing the scaling function and transmits the print data to the printer.

Therefore, in the present embodiment, it is determined whether a printer can execute the scaling function based on the capability information about the printer. As a result of the determination, when it is determined that the printer can execute the scaling function, the expansion application generate the print data including the scaling ratio and transmits the print data to the printer. On the other hand, when it is determined that the printer cannot execute of the scaling function, the expansion application generates the print data obtained by executing the scaling function, that is, by reflecting the execution of the scaling function, to the drawing data and transmits the print data to the printer. Accordingly, even when the printer 102 cannot execute the scaling function, the scaling function may be provided to the user.

The present embodiment is the same as the first embodiment except the configuration of the print system 1000 in the case where an expansion application 902 is associated, the editing process of the PDC, and the process after the drawing application 201 accepts the print setting.

FIG. 9 is a block diagram illustrating a software configuration of a print system according to the second embodiment. The block diagram shown in FIG. 9 illustrates the configuration in the case where the expansion application 902 is associated with the general-purpose print software 202 and a printer 901. As shown in FIG. 9, the host computer 101 includes the drawing application 201, the general-purpose print software 202, the print function information 203, and the expansion application 902. The expansion application 902 is communicably connected to the printer 901. The printer 901 is different from the printer 102 in the first embodiment and cannot execute the scaling function.

The expansion application 902 includes the print-setting-screen expansion unit 205, the intermediate data editing unit 207, the notification unit 209, a print function expansion unit 903, and a scaling unit 904. Even when it is determined that the printer 901 cannot execute the scaling function based on the capability information obtained from the printer 901, the print function expansion unit 903 can add the scaling function to the print function information 203. The scaling unit 904 performs the scaling process on the intermediate data (drawing data) obtained from the general-purpose print software 202 based on the scaling ratio set by the user.

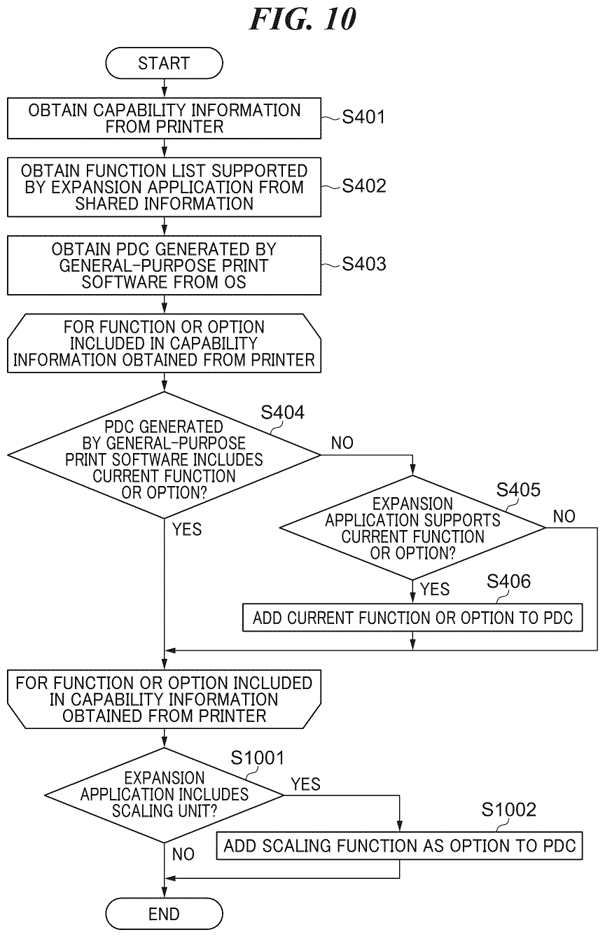

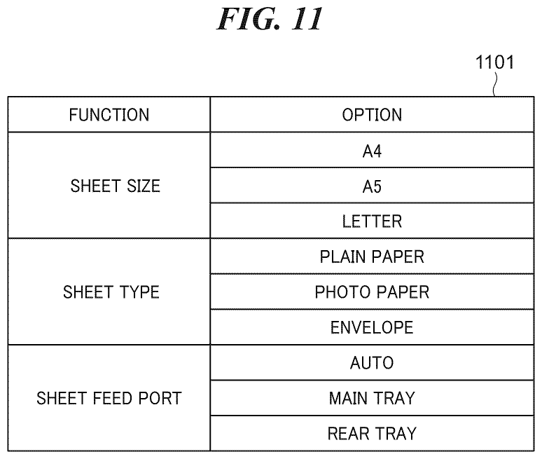

FIG. 10 is a flowchart illustrating a process in which the print function expansion unit edits the print function information. Note that a program based on the flowchart shown in FIG. 10 is executed by the CPU 111 controlling the print function expansion unit 903. In addition, the flowchart shown in FIG. 10 is configured by adding a step S1001 and a step S1002 to the flowchart shown in FIG. 4. FIG. 11 is a view illustrating an example of a list of capability information about the printer.

As shown in FIG. 10, when the repetitive process from the step S404 to the step S406 is completed, the process proceeds to the step S1001. A table 1101 shown in FIG. 11 lists the capability information about the printer 901. The table 1101 includes, as the capability information, information about a sheet size, information about a sheet type, and information about a sheet feed port, but does not include information about the scaling function unlike the table 501 shown in FIG. 5. This shows that the printer 901 cannot execute the scaling function. Therefore, the scaling function is not added to the print capability information 203 after executing the process from the step S404 to the step S406.

As shown in FIG. 10, in the step S1001, the print function expansion unit 903 determines whether the expansion application 902 includes the scaling unit 904, that is, the presence or absence of the scaling unit 904. As a result of the determination in the step S1001, when it is determined that the scaling unit 904 is included, the process proceeds to the step S1002. On the other hand, as a result of the determination in the step S1001, when it is determined that there is no scaling unit 904, the process ends. As described above, since the expansion application 902 includes the scaling unit 904, the process proceeds to the step S1002.

In the step S1002, the print function expansion unit 903 adds the information about the scaling function in the table 601 shown in FIG. 6 to the print capability information 203.

As described above, the expansion application 902 can add, to the print function information 203, a function or option that is not supported by the general-purpose print software 202, and is supported by the printer 901 and the expansion application 902. Then, the expansion application 902 determines whether the scaling unit 904 is included. As a result of this determination, when it is determined that the scaling unit 904 is included, the scaling function is added to the print function information 203. This addition process enables to generate the capability information based on the print function information 203 to which the scaling function is added, even when the printer 901 cannot execute the scaling function. The expansion application 902 can display the advanced setting screen 300C shown in FIG. 3C by generating a display screen based on the capability information.

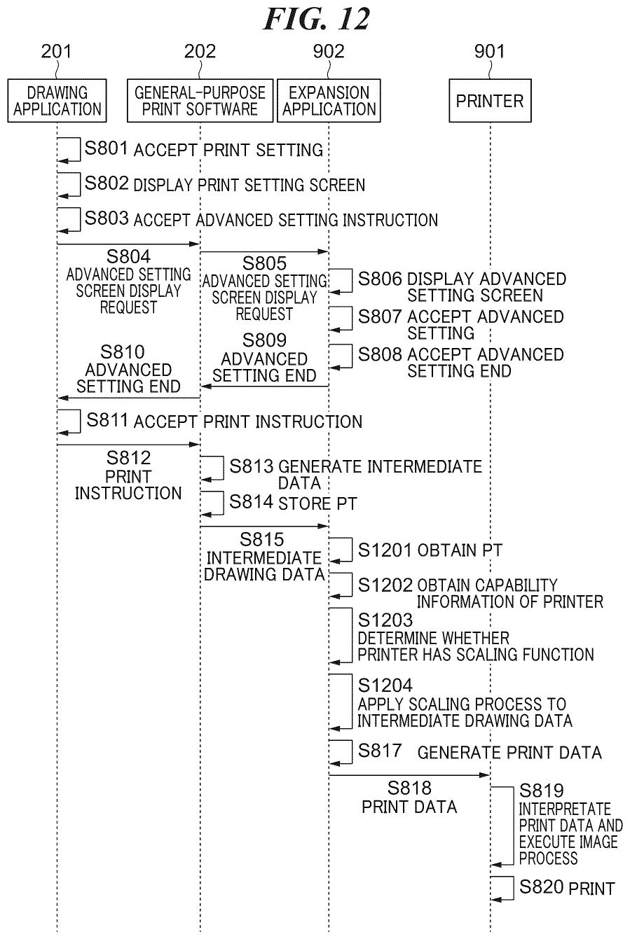

FIG. 12 is a sequence chart illustrating a process executed among a drawing application, the general-purpose print software, the expansion application, and the printer after the drawing application accepts a print setting. The sequence chart shown in FIG. 12 is configured by mainly adding steps S1201 to S1204 to the sequence chart shown in FIG. 8.

As shown in FIG. 12, the process proceeds to the step S1201 after executing the step S815. In the step S1201, the scaling unit 904 of the expansion application 902 obtains the print setting information (PT) stored in the step S814 from the shared information 208. The scaling unit 904 obtains information about the scaling function included in the print setting information. When the scaling ratio in the information about the scaling function is a numerical value of 100%, the scaling process is not executed, and thus the process omits the steps S1202 to S1204.

In the step S1202, the scaling unit 904 obtains the capability information about the printer 901 from the shared information 208. When the capability information about the printer 901 is not included in the shared information 208, the print function expansion unit 903 may request the capability information from the printer 901. Also in this case, the capability information is stored in the shared information 208.

In the step S1203, the scaling unit 904 determines whether the printer 901 has the scaling function based on the capability information obtained in the step S1202. As described above, the printer 901 in the present embodiment cannot execute the scaling function. Therefore, it is determined in the step S1203 that the printer 901 does not have the scaling function. If it is determined in the step S1203 that a printer has the scaling function, the process skips the step S1204 and proceeds to the step S817. This is because a general printer can perform the scaling function at a higher speed than the scaling unit 904. Specifically, a general printer can execute the scaling process at a higher speed than the scaling unit 904 by using an ASIC (application specific integrated circuit).

In the step S1204, the scaling unit 904 scales intermediate drawing data (intermediate data) with the scaling ratio based on the information related to the scaling function setting obtained in the step S1201 and generates scaled data (a generation step). The processing result is stored in the shared information 208. The scaling unit 904 edits the scaling ratio in the print setting information to “100” or deletes the scaling ratio from the print setting information. After executing the step S1204, the process proceeds to the steps S817 to S820 in order. The print data transmitted in the step S818 is the scaled data generated in the step S1204. Then, the printed sheet to which the scaling function has been executed, that is, the scaling has been reflected, is obtained in the step S820.

As described above, in the present embodiment, even when the printer 901 cannot execute the scaling function, the expansion application 902 is able to execute the scaling function. As a result, the printed sheet in which the scaling is reflected is printed with the printer 901.

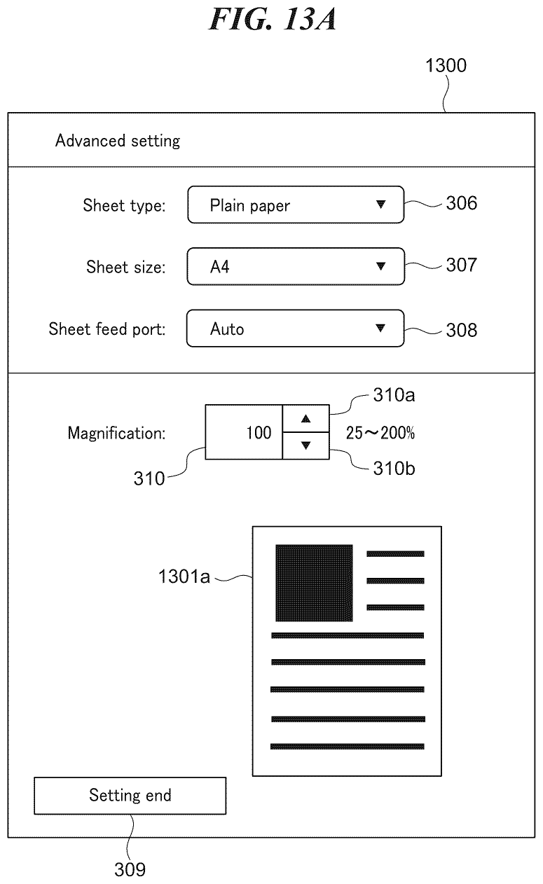

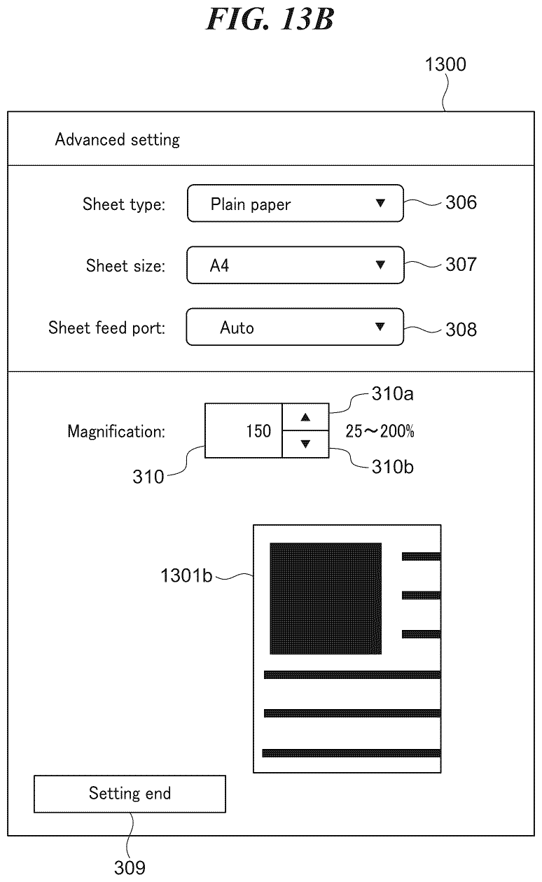

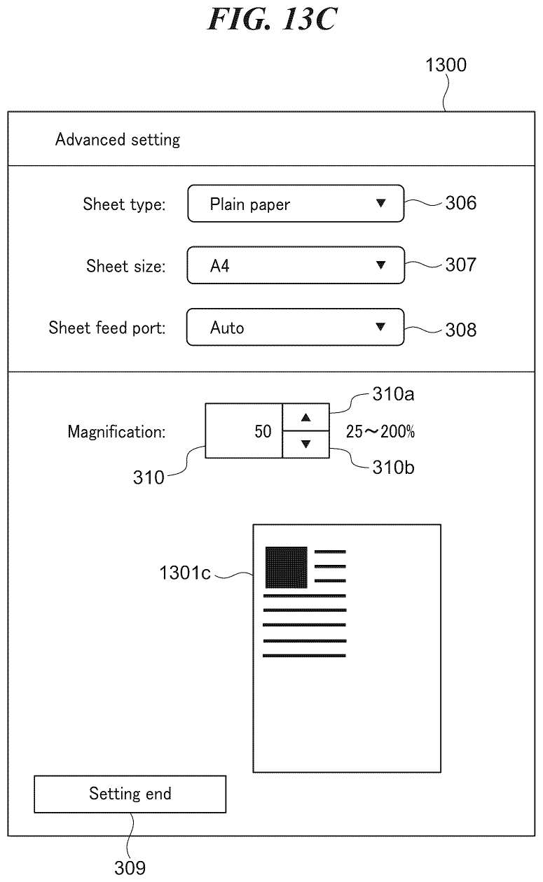

Hereinafter, a third embodiment will be described with reference to FIG. 13A to FIG. 13C. Differences from the above-described embodiments will be mainly described, and the description of the same matters will be omitted. The present embodiment is the same as the first embodiment except that the configuration of the advanced setting screen is different.

FIG. 13A to FIG. 13C are views illustrating examples of screens displayed on the display unit of the print system according to the third embodiment. FIG. 13A shows an advanced setting screen 1300 when the scaling ratio is 100%. FIG. 13B shows the advanced setting screen 1300 when the scaling ratio is 150%. FIG. 13C shows the advanced setting screen 1300 when the scaling ratio is 50%. As shown in FIG. 13A to FIG. 13C, the advanced setting screens 1300 includes preview image 1301a, 1303b, and 1301c of printed sheets obtained by printing data with the printer 102.

Note that the preview images 1301a, 1301b, and 1301c are simple images obtained by scaling up or down an image of a specific illustration in accordance with the designated scaling ratios, unlike a general preview image. As a result, each of the preview images 1301a, 1301b, and 1301c can be displayed at a higher speed than displaying a general preview image. Although the preview images 1301a, 1301b, and 1301c are arranged below the control 310 in the configuration illustrated in FIG. 13A to FIG. 13C, this is not limited.

As shown in FIG. 13A, 100% is input as the scaling ratio to the control 310 on the advanced setting screen 1300. The preview image 1301a in this case is an image of the print data that is not scaled. As shown in FIG. 13B, 150% is input as the scaling ratio to the control 310 on the advanced setting screen 1300. The preview image 1301b in this case is an image of the print data ton which the scaling ratio of 150% is reflected, that is, enlarged to 150%. The preview image 1301b is an image in an upper left region of the preview image 1301a.

As shown in FIG. 13C, 50% is input as the scaling ratio to the control 310 on the advanced setting screen 1300. The preview image 1301c in this case is an image of the print data in which the scaling ration of 50% is reflected, that is, reduced to 50%. The preview image 1301c is an image of the entire print data disposed in the upper left region of the sheet. The preview images 1301a to 1301c allow the user to understand what printed sheet will be obtained from the printer 102 before the printing.

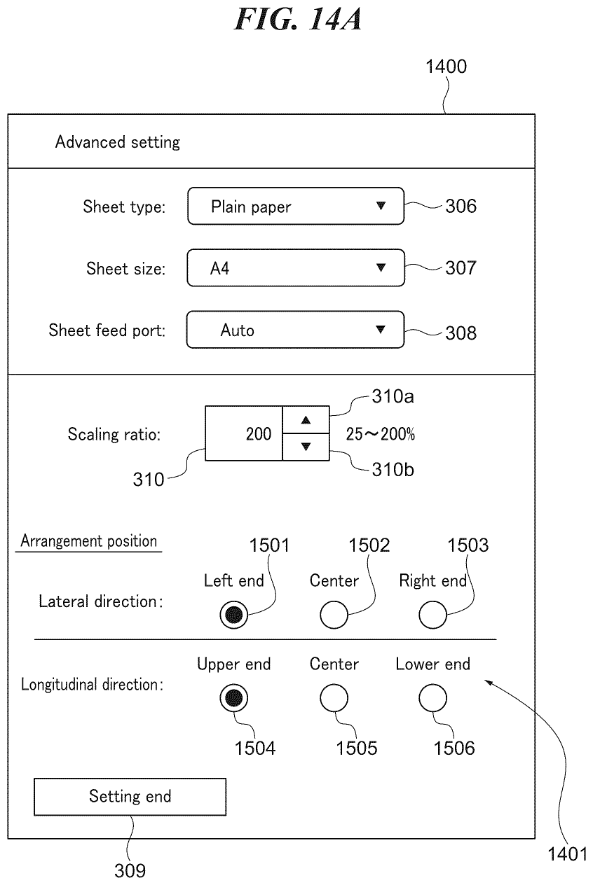

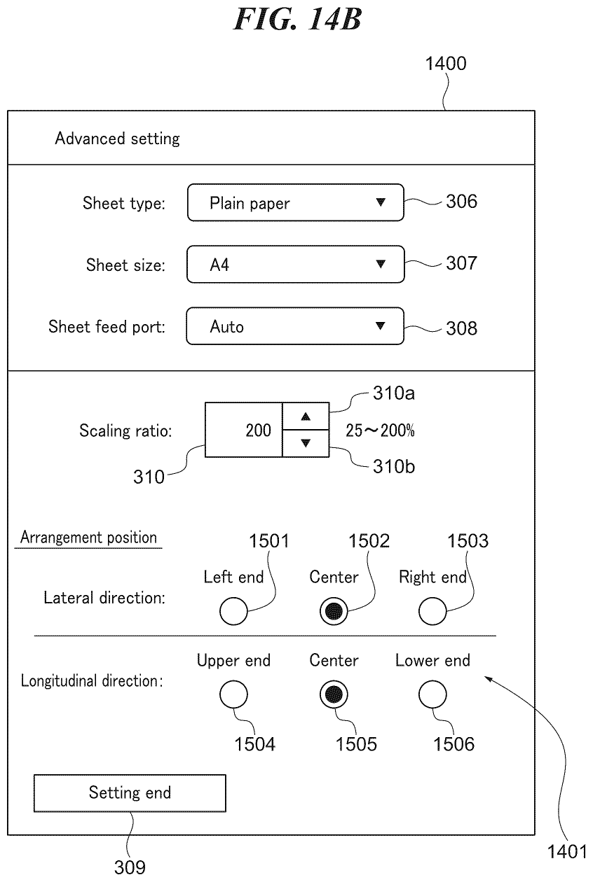

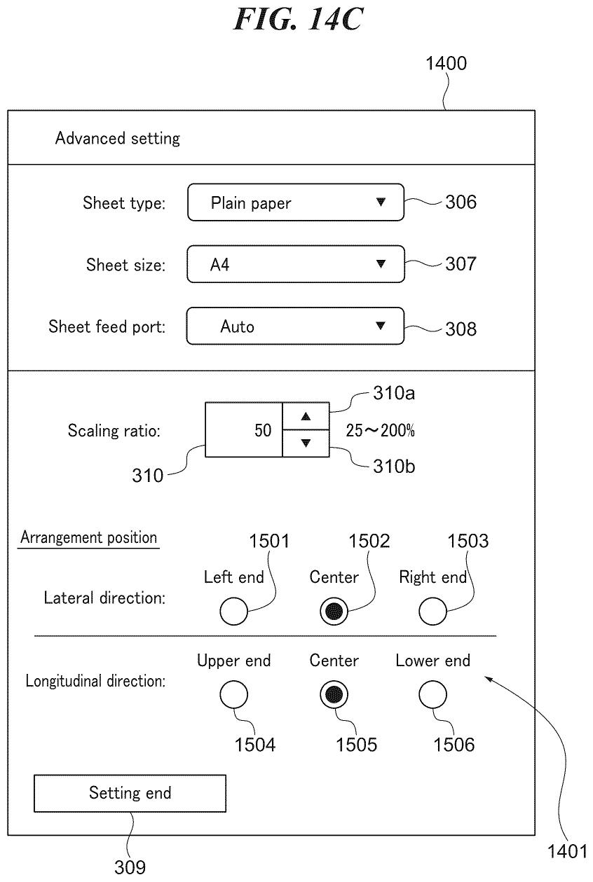

Hereinafter, a fourth embodiment will be described with reference to FIG. 14A to FIG. 14C. Differences from the above-described embodiments will be mainly described, and the description of the same matters will be omitted.

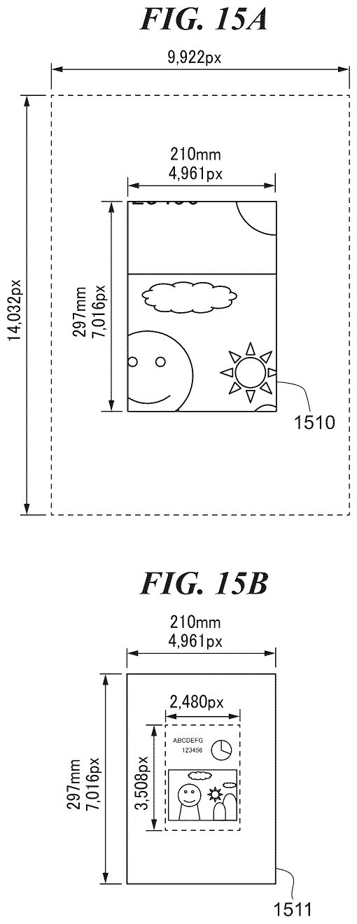

FIG. 14A to FIG. 14C are views illustrating examples of advanced setting screens (setting accepting screens) displayed on the display unit of the print system according to the fourth embodiment. FIG. 14A shows an advanced setting screen 1400 when the scaling ratio is 200%, and an arrangement position of the print data is a left end in the lateral direction and an upper end in the longitudinal direction. FIG. 14B shows the advanced setting screen 1400 when the scaling ratio is 200%, and the arrangement position of the print data is a center in the lateral direction and a center in the longitudinal direction. FIG. 14C shows the advanced setting screen 1400 when the scaling ratio is 50%, and the arrangement position of the print data is the center in the lateral direction and the center in the longitudinal direction. FIG. 15A and FIG. 15B are views illustrating examples of print positions of the print data on the print sheet.

As shown in FIG. 14A to FIG. 14C, the advanced setting screen 1400 includes a designation area 1401 for designating the print position of the print data with respect to the print sheet on which the print data is printed with the printer 102. The designation area 1401 includes controls 1501 to 1506. The control 1501 is a left end designation checkbox that is checked when the left end in the lateral direction is designated as the print position of the print data on the print sheet. The control 1502 is a center designation checkbox that is checked when the center is designated. The control 1503 is a right end designation checkbox that is checked when the right end is designated. The control 1504 is an upper end designation checkbox that is checked when the upper end in the longitudinal direction is designated as the print position of the print data on the print sheet. The control 1505 is a center designation checkbox that is checked when the center is designated. The control 1506 is a lower end designation checkbox that is checked when the lower end is designated.

In this way, in the designation area 1401, the print position of the print data in the lateral direction of the print sheet is selectable from among a plurality of choices (three choices), and the print position of the print data in the longitudinal direction of the print sheet is selectable from among a plurality of choices (three choices). The number of choices in each direction is not limited to three. In addition, although the designation area 1401 is arranged below the control 310 in the configuration shown in FIG. 14A to FIG. 14C, this is not limited.

In the advanced setting screen 1400 shown in FIG. 14A, the numerical value 200(%) is input to the control 301, and the controls 1501 and 1504 are checked. In this input state, for example, as shown in FIG. 2D, an upper left part of the print data after the enlargement process is printed on the print sheet 2001.

In the advanced setting screen 1400 shown in FIG. 14B, the numerical value 200(%) is input to the control 301, and the controls 1502 and 1505 are checked. In this input state, as shown in FIG. 15A, a center part of the print data after the enlargement process is printed on a print sheet 1510.

In the advanced setting screen 1400 shown in FIG. 14C, the numerical value 50(%) is input to the control 301, and the controls 1502 and 1505 are checked. In this input state, as shown in FIG. 15B, the print data after the reduction process is printed at the center of a print sheet 1511.

Although the designation area 1401 includes the controls 1501 to 1506, this is not limited. For example, the designation area 1401 may be configured to allow the user to designate the print position of the print data on the print sheet by a mouse, a touch panel, or the like. The designation area 1401 may be configured to allow the user to input the print position of the print data on the print sheet as a numerical value. In this case, it is preferable that the numerical values are a distance (mm) from the upper end of the print sheet and a distance (mm) from the left end.

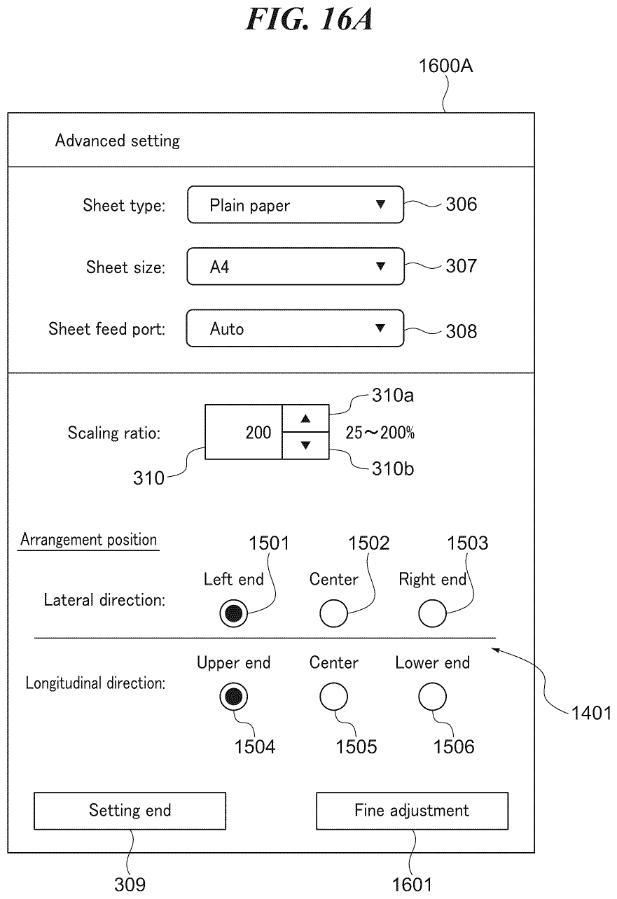

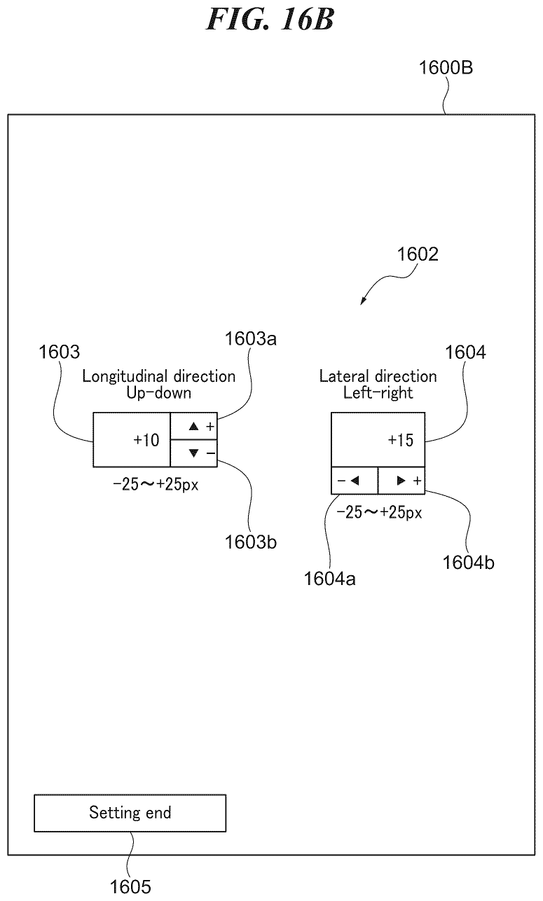

Hereinafter, a fifth embodiment will be described with reference to FIG. 16A and FIG. 16B. Differences from the above-described embodiments will be mainly described, and the description of the same matters will be omitted.

FIG. 16A and FIG. 16B are views illustrating examples of screens displayed on the display unit of the print system according to the fifth embodiment. FIG. 16A shows an advanced setting screen 1600A when the scaling ratio is 200%, and the arrangement position of the print data is the left end in the lateral direction and the upper end in the longitudinal direction. In this input state, the upper left portion of the enlarged print data is printed on the print sheet. FIG. 16B shows an advanced setting screen 1600B that has transitioned from the advanced setting screen 1600A shown in FIG. 16A.

As shown in FIG. 16A, the advanced setting screen 1600A includes a control 1601 in addition to the configuration of the advanced setting screen 1400 shown in FIG. 14A. The control 1601 is a button that is operated when the print position of the print data designated in the designation area 1401 is further finely adjustment. By operating the control 1601, the advanced setting screen 1600A is shifted to the advanced setting screen 1600B shown in FIG. 16B.

The advanced setting screen 1600B includes a fine adjustment area 1602. The fine adjustment area 1602 includes controls 1603 and 1604. Although the controls 1603 and 1604 are arranged side by side in the advanced setting screen 1600B in the configuration illustrated in FIG. 16B, this is not limited. The controls 1603 and 1604 may be included in the advanced setting screen 1600A. In this case, the controls 1603 and 1604 are preferably displayed in a gray-out manner until the control 1601 is operated. When the control 1601 is operated, the grayed-out display of the controls 1603 and 1604 is canceled, and the controls are brought into a state where numerical values can be input.

The control 1603 is an input box in which a fine adjustment position of the print data in the longitudinal direction (up-down direction) of the print sheet is input as a numerical value. In the control 1603, an up button 1603a for raising, that is, increasing the numerical value in the control 1603 and a down button 1603b for lowering, that is, decreasing the numerical value are arranged vertically. The numerical value in the control 1603 can be changed by 1px and set to a desired size by appropriately pressing the up button 1603a or the down button 1603b. In FIG. 16B, the numerical value “+10” is set as an example.

A change width of the numerical value per one press operation on the up button 1603a or the down button 1603b is not limited to 1px, and may be 2px, for example. In addition, a numerical value range that can be input to the control 1603 is defined. Thus, a numerical value within an allowable range of the fine adjustment can be input. Although the allowable range is defined as “−25px to +25px” in the example shown in FIG. 16B, this is not limited.

The control 1604 is an input box in which a fine adjustment position of the print data in the lateral direction (left-right direction) of the print sheet is input as a numerical value. In the control 1604, an up button 1604a for raising the numerical value in the control 1604 and a down button 1604b for lowering the numerical value are arranged horizontally. The numerical value in the control 1604 can be changed by 1px and set to a desired size by appropriately pressing the up button 1604a or the down button 1604b. In FIG. 16B, the numerical value “+15” is set as an example.

A change width of the numerical value per one press operation on the up button 1604a or the down button 1604b is not limited to the same change width as the control 1603, and may be different from the change width of the control 1603. In addition, a numerical value range that can be input to the control 1604 is defined. Thus, a numerical value within an allowable range of the fine adjustment can be input. Although the allowable range is defined as “−25px to +25px” in the example shown in FIG. 16B as with the control 1603, this is not limited. The advanced setting screen 1600B also includes a control 1605. The control 1605 is a button to fix the fine adjustment with the numerical values input to the controls 1603 and 1604. In addition, when the control 1605 is operated, the screen is transitions to the advanced setting screen 1600A.

According to the present disclosure, the scaling ratio used when print data is scaled and printed with a printer can be changed by a numerical value.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090739, filed Jun. 4, 2024, which is hereby incorporated by reference herein in its entirety.

What is claimed is:

1. A non-transitory computer-readable storage medium storing a program supporting a general-purpose print software that generates print data printable by printers of a plurality of manufacturers and transmits the print data to a printer, the program causing a computer to execute a control method comprising:
displaying a setting accepting screen on which a scaling ratio used when the print data is scaled and printed with the printer is accepted by a numerical value; and
transmitting numerical value information including the numerical value accepted on the setting accepting screen to the printer.

2. The non-transitory computer-readable storage medium according to claim 1, wherein the printer is able to scale the print data based on the numerical value information transmitted and print the print data scaled.

3. A non-transitory computer-readable storage medium storing a program supporting a general-purpose print software that generates print data printable by printers of a plurality of manufacturers, the program causing a computer to execute a control method comprising:
displaying a setting accepting screen on which a scaling ratio used when the print data is scaled and printed with the printer is accepted by a numerical value;
generating scaled data by scaling the print data using the numerical value accepted on the setting accepting screen; and
transmitting the scaled data to the printer.

4. The non-transitory computer-readable storage medium according to claim 1, wherein the method further comprising:
obtaining capability information related to a print capability of the printer from the printer before displaying the setting accepting screen;
determining whether the capability information obtained includes information that enables to display the setting accepting screen;
displaying the setting accepting screen in a case where it is determined that the information that enables to display the setting accepting screen is included; and
not displaying the setting accepting screen in a case where it is determined that the information that enables to display the setting accepting screen is not included.

5. The non-transitory computer-readable storage medium according to claim 1, wherein the setting accepting screen includes at least one input box in which the numerical value is input.

6. The non-transitory computer-readable storage medium according to claim 5, wherein a numerical value range that can be input to the input box is defined.

7. The non-transitory computer-readable storage medium according to claim 5, wherein the scaling ratio includes a longitudinal scaling ratio in a longitudinal direction of a print sheet on which the print data is printed with the printer and a lateral scaling ratio in a lateral direction of the print sheet, and
wherein the setting accepting screen includes, as the at least one input box, a first input box in which the longitudinal scaling ratio is input and a second input box in which the lateral scaling ration is input.

8. The non-transitory computer-readable storage medium according to claim 7, wherein a numerical value range that can be input to the first input box and a numerical value range that can be input to the second input unit are defined.

9. The non-transitory computer-readable storage medium according to claim 1, wherein the setting accepting screen includes a designation area for designating a print position of the print data with respect a print sheet on which the print data is printed with the printer.

10. The non-transitory computer-readable storage medium according to claim 9, wherein the print position of the print data in a longitudinal direction of a print sheet is selectable from among a plurality of choices, and the print position of the print data in a lateral direction of the print sheet is selectable from among a plurality of choices.

11. The non-transitory computer-readable storage medium according to claim 1, wherein a preview image of a printed sheet obtained with the printer by printing the print data to which the scaling with the numerical value is reflected is displayed on the setting accepting screen.

12. The non-transitory computer-readable storage medium according to claim 1, wherein a function of accepting the scaling ratio as the numerical value is not executable by the general-purpose print software with respect to the printer.

13. The non-transitory computer-readable storage medium according to claim 1, wherein a program operating based on Internet Printing Protocol is used as the general-purpose print software.

14. A control method supporting a general-purpose print software that generates print data printable by printers of a plurality of manufacturers and transmits the print data to a printer, the control method comprising:
displaying a setting accepting screen on which a scaling ratio used when the print data is scaled and printed with the printer is accepted by a numerical value; and
transmitting numerical value information including the numerical value accepted on the setting accepting screen to the printer.
